(19) United States
(12) Patent Application Publication
(10) Pub. No.: US 2026/0288714 A1
(43) Pub. Date: Sep. 24, 2026

(54) SYSTEM

(71) Applicant: SoftBank Group Corp., Tokyo (JP)

(72) Inventor: Hirohito FUJIKI, Tokyo (JP)

(73) Assignee: SoftBank Group Corp., Tokyo (JP)

(21) Appl. No.: 19/564,438

(22) Filed: Mar. 12, 2026

(30) Foreign Application Priority Data
Mar. 19, 2025 (JP) 2025-045048

(51) Int. Cl. G06F 16/2452

(52) U.S. Cl. CPC G06F 16/24522; G06F 16/24528

(57) ABSTRACT

A system includes a processor that is configured to obtain information by using a communication means that enables exchange of information with a user, analyze the obtained information by using a data analysis means, analyze user information by using a generative AI model and generate a prompt for instructing a specific processing, and propose a product based on the generated prompt.

### CROSS-REFERENCE TO RELATED APPLICATION

This application is based on and claims priority under 35 USC 119 from Japanese Patent Application No. 2025-045048 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional product recommendation systems generally rely on fixed rule-based logic or simple statistical models, and therefore have limited capability to understand complex, context-dependent user needs expressed in natural language. As a result, such systems frequently fail to accurately interpret nuanced user requests, preferences, and constraints, leading to inadequate or irrelevant product proposals. Furthermore, conventional systems often separate the processes of information acquisition, data analysis, and recommendation generation, which increases system complexity and reduces overall efficiency. There is thus a need for a system that can seamlessly acquire information from a user, analyze the information in an integrated manner, and generate accurate, context-sensitive product proposals by using a generative AI model, while enabling flexible communication and personalized display of product information.

### SUMMARY

In order to solve the above-described problem, according to one aspect of the present invention, there is provided a system comprising a processor, wherein the processor is configured to obtain information by using a communication means that enables exchange of information with a user, analyze the obtained information by using a data analysis means, analyze user information by using a generative AI model and generate a prompt for instructing a specific processing, and propose a product based on the generated prompt. In one embodiment, the processor is configured to use a communication application for exchanging information with the user via the Internet, thereby allowing the user to input requests or questions through a messenger or similar interface. In another embodiment, the processor is configured to use a display device for displaying personalized product information based on a request or a preference of the user, so that the user can receive product proposals that are tailored to individual needs and contexts. Through the integration of these functions, the system can accurately interpret user inputs, efficiently generate prompts for specific processing, and provide appropriate product proposals in a unified and interactive manner.

The term “processor” refers to one or more hardware computing units, such as a central processing unit (CPU), a graphics processing unit (GPU), a microcontroller, or any combination thereof, capable of executing instructions to perform the functions described in the present specification.

The term “communication means” refers to any hardware and/or software component configured to enable exchange of information between the system and a user, including but not limited to network interfaces, communication modules, and associated protocols for wired or wireless communication.

The term “communication application” refers to software executed on a terminal or server that enables the exchange of messages or data with a user via a network, including but not limited to messenger applications, chat applications, web-based communication tools, and similar Internet-based communication services.

The term “data analysis means” refers to one or more software modules, hardware modules, or a combination thereof, configured to process, analyze, and interpret data obtained from a user or other sources, including but not limited to statistical analysis, pattern recognition, and machine learning-based analysis.

The term “generative AI model” refers to an artificial intelligence model configured to generate content or outputs, such as text, based on input data, including but not limited to large language models, transformer-based models, or other neural network architectures capable of generating prompts or other data.

The term “prompt” refers to information generated by the generative AI model that is used to instruct, parameterize, or guide a specific processing operation within the system, such as a product recommendation process or other downstream computational tasks.

The term “specific processing” refers to one or more predetermined or dynamically determined operations executed by the system in response to a prompt, including but not limited to product recommendation, filtering, ranking, or personalization of information.

The term “product” refers to any goods or services, whether physical or digital, that can be proposed, displayed, or recommended to a user by the system.

The term “propose a product” refers to causing information related to one or more products to be output to a user, including presenting product candidates, recommendations, rankings, or selections based on analysis results or generated prompts.

The term “display device” refers to any hardware component capable of visually presenting information to a user, including but not limited to a liquid crystal display (LCD), organic light-emitting diode (OLED) display, computer monitor, smartphone screen, tablet display, or head-mounted display.

The term “personalized product information” refers to information relating to one or more products that is tailored to a specific user based on the user's requests, preferences, profile, or behavior history, such that the content, layout, or selection of products differs between users.

The term “user information” refers to any information related to a user, including but not limited to user inputs, requests, questions, preferences, profile data, purchase history, browsing history, and interaction logs acquired by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

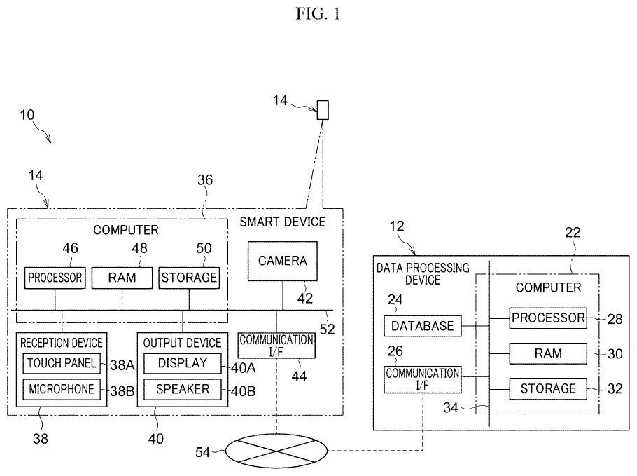

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

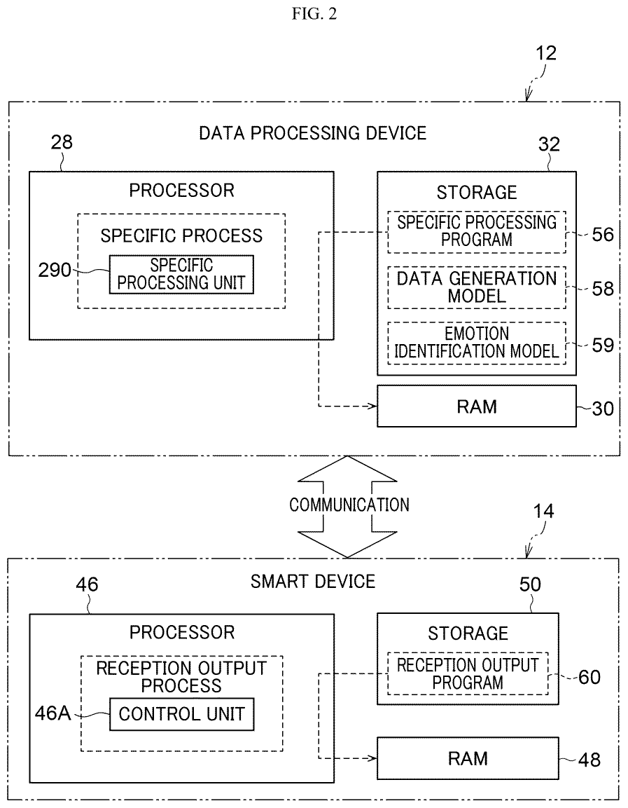

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional product recommendation systems that operate over communication networks typically treat user input as a simple search query and directly match the input text against a product catalog or a rule set. Such systems often lack an intermediate semantic interpretation layer and therefore fail to accurately capture a user's purchasing intent, contextual constraints, and nuanced preferences expressed in natural language. As a result, conventional systems frequently return overly broad, irrelevant, or insufficiently personalized product suggestions, which degrades user experience and reduces the effectiveness of the recommendation service.

In addition, many existing systems that employ machine learning models or information retrieval techniques are configured with static query templates or fixed feature extraction pipelines. These systems do not dynamically transform raw user input into an optimized prompt for subsequent automated reasoning, and they do not leverage iterative interaction with a generative artificial intelligence model. Consequently, the underlying computer processes perform sub-optimal text analysis and recommendation computation, leading to inefficient use of computational resources, redundant network calls, and an inability to adapt to diverse user expressions or evolving product attributes.

Further, in systems that do utilize generative artificial intelligence models, such models are often invoked in a monolithic manner: a single request is sent to the model, which attempts to directly produce a final recommendation. This approach does not separate the task of clarifying the user's intent from the task of generating concrete product proposals. Without this separation, the internal computation performed by the model and the surrounding software infrastructure cannot be effectively controlled, logged, or optimized. This limits traceability and hinders systematic improvement of the recommendation quality.

Moreover, conventional architectures typically do not maintain a structured correspondence between intermediate prompt sentences and resulting recommendation content as machine-readable history. Without such history information, the system cannot programmatically adjust preprocessing parameters or model input parameters for different users based on observed performance. As a result, the computing system cannot effectively refine its behavior over time to improve personalization, and the computer resources are not exploited to incrementally enhance the accuracy and efficiency of the recommendation pipeline.

Accordingly, there is a need for a computer-implemented system that improves the way in which a processor acquires, preprocesses, and transforms user input into an internal representation and into a prompt sentence for a generative artificial intelligence model, and that uses the generated prompt sentence in a structured, stepwise manner to obtain and deliver product recommendation content. There is also a need for a system that stores and exploits the relationship between prompt sentences and recommendation results so as to adapt preprocessing and model parameters for each user, thereby improving both the technical performance of the recommendation computation and the quality of the personalized product information presented to the user.

The specific processing by the specific processing unit 290 of the data processing device 12 in Example 1 is realized by the following means.

The present invention provides a server comprising a processor configured to acquire user input information as text data via a communication device and a communication program, to perform preprocessing including normalization and structuring of the text data to generate internal representation data indicating user intent and product conditions, to invoke a generative artificial intelligence model via an external information processing service using the internal representation data and the input information as input so as to generate a prompt sentence for product recommendation, to further obtain product recommendation content by executing the generative artificial intelligence model or another information retrieval process using the prompt sentence as input, to construct product information including product category information and product attribute information based on the product recommendation content and generate response data, and to transmit the response data to a terminal, and further configured to control generation of a plurality of messages including a system message and a user message as input to the generative artificial intelligence model and to embed the input information and the internal representation data into the user message in order to stepwise execute a process for generating the prompt sentence and a process for generating the product recommendation content, and further configured to store, as history information in a storage device, a correspondence between the prompt sentence and the product recommendation content and to modify at least one of preprocessing contents and input parameters to the generative artificial intelligence model based on the history information. This enables an improvement in computer functionality by structuring the natural-language interaction into explicit intermediate prompt sentences, by optimizing model invocation and preprocessing pipelines in a feedback-driven manner, and by enhancing the efficiency, accuracy, and personalization of machine-implemented product recommendation processing executed by the server.

The term “processor” refers to a hardware information processing unit, or a combination of such units, that executes machine-readable instructions to perform data acquisition, data transformation, model invocation, and communication control in the system.

The term “user” refers to a human operator or an entity that provides input information regarding products and receives product information through a terminal connected to the system.

The term “terminal” refers to an information processing device, such as a mobile device, a tablet device, a desktop device, or any other client device, that executes a communication program to exchange information with the server and to present product information to the user.

The term “communication device” refers to a hardware communication interface, such as a network interface controller or a wireless communication module, that enables data transmission and reception between the server and the terminal via a communication network.

The term “communication program” refers to software executed by the terminal or the server that controls data exchange over a network, including transmission of user input information and reception of response data according to a communication protocol.

The term “user input information” refers to data provided by the user, including a request or a question regarding a product, typically represented as natural-language text acquired through the terminal.

The term “text data” refers to digital data representing characters or strings, including natural-language expressions of a user's request or question, encoded in a character encoding scheme and processed by the system.

The term “preprocessing” refers to a series of data processing operations applied to text data prior to model invocation, including at least character string normalization processing and structuring processing to generate internal representation data.

The term “character string normalization processing” refers to data processing that converts text data into a standardized form, including operations such as trimming, case normalization, removal of control characters, and unification of character variants.

The term “structuring processing” refers to data processing that converts unstructured text data into a structured internal format, such as key-value pairs or feature vectors, representing elements of user intent and product-related conditions.

The term “internal representation data” refers to structured data generated by preprocessing that expresses extracted feature information, including user intent and product conditions, in a form suitable as input to a generative artificial intelligence model or other computational modules.

The term “user intent” refers to a semantic objective of the user, such as a desired product type, usage scenario, or preference, inferred from the user input information and represented in the internal representation data.

The term “product conditions” refers to constraints or preferences related to a product, such as category, function, use case, or qualitative attributes, derived from the user input information and expressed in the internal representation data.

The term “feature information” refers to data elements extracted from user input information that characterize user intent and product conditions for use in further computational processing.

The term “generative artificial intelligence model” refers to a machine learning model, such as a neural network model, configured to generate text or other data in response to an input, and used by the system to produce a prompt sentence and product recommendation content.

The term “external information processing service” refers to a remotely provided computation environment, accessible via a network, that executes the generative artificial intelligence model on behalf of the server and returns generated results.

The term “prompt sentence” refers to an instruction sentence generated using the generative artificial intelligence model based on user input information and internal representation data, and used as an intermediate representation for product recommendation.

The term “product recommendation content” refers to information generated using the prompt sentence as input, indicating suggested products, product types, or product characteristics that respond to the user's request or question.

The term “recommendation information” refers to data, including the product recommendation content, that represents one or more recommended products or product options associated with the prompt sentence.

The term “information retrieval process” refers to a computational process, such as a search or query operation, that acquires product-related data from a storage system or database based on the prompt sentence or derived conditions.

The term “product information” refers to data describing products, including at least product category information and product attribute information, which is constructed by the processor based on the recommendation information.

The term “product category information” refers to data indicating a classification of products, such as a general type, group, or category used to organize products in the system.

The term “product attribute information” refers to data representing characteristics of products, such as features, functions, usage conditions, sizes, colors, materials, or other descriptive properties.

The term “response data” refers to data generated by the processor for transmission to the terminal, including at least the product information that is to be presented to the user.

The term “system message” refers to a message element supplied to the generative artificial intelligence model that defines a role, constraint, or behavior to be followed by the model during generation.

The term “user message” refers to a message element supplied to the generative artificial intelligence model that includes user input information and internal representation data, and represents the specific request to be processed by the model.

The term “plurality of messages” refers to two or more message elements, including at least a system message and a user message, that collectively form the input to the generative artificial intelligence model.

The term “stepwise execution” refers to a control method in which a process for generating the prompt sentence and a process for generating the product recommendation content are performed in separate, ordered stages using distinct inputs or model invocations.

The term “history information” refers to data stored in a storage device that records a correspondence between generated prompt sentences and associated product recommendation content, and optionally includes contextual metadata.

The term “storage device” refers to a hardware data storage component, such as a magnetic storage device, a solid-state storage device, or another non-volatile or volatile memory device, used to store history information and other data.

The term “input parameter” refers to a configurable value provided to the generative artificial intelligence model, such as a temperature, a maximum output length, a model identifier, or another control parameter affecting model behavior.

The term “contents of the preprocessing” refers to specific operations, rules, or configurations applied during preprocessing of text data, including which normalization and structuring procedures are executed and how they are parameterized.

The term “personalized product information” refers to product information whose content or presentation is adjusted based on characteristics, preferences, or past interactions of an individual user, using the history information and modified processing parameters.

In one embodiment, a server, a terminal, and a user cooperate through a communication network to implement the claimed system. The server comprises at least one processor, a main memory, a storage device, and a network interface device. The terminal comprises a processor, a memory, a display device, an input device, and a network interface device. The user operates the terminal to provide input information, and the server executes software modules to perform preprocessing, generative AI based prompt sentence generation, product recommendation computation, and response transmission.

The server uses a general-purpose computing platform, such as a rack-mounted computer or a virtual machine instance, equipped with a central processing unit (for example, an x86-compatible multi-core processor), a main memory, and a non-volatile storage device (for example, a solid-state drive). The server executes an operating system (for example, a Unix-like operating system) and a web application framework (for example, a server-side framework that supports HTTP and JSON communication). The server further uses a software development kit or an application programming interface client library to access a generative AI model provided by an external information processing service. The server may communicate with a remote inference cluster that internally employs graphics processing units, such as programmable vector processors, to execute a large-scale neural network.

The terminal uses a mobile computing device or a personal computing device, such as a smartphone, tablet, or laptop. The terminal executes a communication program implemented as a native application or a web-based application. The terminal uses its network interface (for example, a wireless LAN module or a cellular communication module) to transmit user input information to the server and to receive response data from the server. The terminal uses its display device, such as a liquid crystal display or an organic light-emitting diode display, to present product information to the user.

The user inputs natural-language text describing a request or question regarding products, such as “I am looking for new running shoes” or “I am looking for cool clothes perfect for summer.” The terminal converts the user's keystrokes or touch input into text data and stores the text data in a buffer in main memory. The terminal then encapsulates the text data in a message structure and transmits the message structure over a network to the server. The message structure may be expressed as an object in a hierarchical data format, but the server ultimately handles the core part as text strings.

The server receives the text data through the network interface and passes it to an application-layer module. The server stores the raw text in memory and, optionally, in a logging storage area. The server applies preprocessing to the text data using a text-processing module. The server normalizes the character string by converting all characters to a uniform case, removing non-printable control characters, and standardizing punctuation and whitespace.

The server then performs tokenization by splitting the text into token units, such as words or subwords, based on a vocabulary and rule set. The server may use algorithms similar to byte-pair encoding or unigram tokenization to generate token identifiers.

The server applies structuring processing by analyzing the token sequence to extract feature information that represents user intent and product conditions. The server may apply part-of-speech tagging and dependency parsing using a natural language processing library, or may apply a smaller, locally hosted neural network that maps token sequences to categories and attributes. The server generates an internal representation data structure, such as a key-value map or a feature vector, that may include fields such as “product_category,” “usage_context,” “constraints,” and “preferences.” For example, for the input “I am looking for new running shoes,” the server may generate internal representation data indicating “product_category: footwear,” “usage_context: running,” and “novelty: new.”

The server uses both the original text data and the internal representation data as inputs to a message construction module. The server generates a system message that instructs a generative AI model to play a specific role and follow specific constraints. For example, the server may generate a system message such as:

“You convert user shopping requests into a clear and concise prompt sentence for product recommendation.”

The server also generates a user message that embeds the original user input and the structured representation. For example, the server may generate a user message such as:

“A user wrote: ‘I am looking for new running shoes.’ The extracted features are: product category is running shoes, usage is daily jogging, and cushioning is important. Convert this into one instruction sentence to be used for product recommendation.”

The server composes a request to a generative AI model that follows a transformer architecture. The generative AI model includes an encoder-decoder or decoder-only neural network with multiple layers of self-attention and feed-forward sub-layers, each layer including weight matrices, bias vectors, and normalization parameters. The generative AI model internally converts each token into a high-dimensional embedding vector, applies positional encoding, and propagates the vectors through attention mechanisms where query, key, and value matrices are multiplied and combined to compute context-dependent representations. The generative AI model applies non-linear activation functions, such as rectified linear units or variants thereof, and performs residual connections and layer normalization at each layer.

The server transmits the system message and the user message to the external information processing service that hosts the generative AI model. The external service converts the text into token identifiers using a predefined vocabulary, applies attention-mask logic and positional indices, and performs a sequence of matrix multiplications and vector additions across the network layers. The model is trained in advance on a large corpus of text using gradient-based optimization. During training, the model minimizes a loss function, such as a cross-entropy loss between predicted token distributions and ground-truth next tokens, and updates model parameters using stochastic gradient descent and its variants, such as Adam or similar algorithms. The training may involve data augmentation such as random masking, dropout, or sequence truncation. The server, in the deployed system, uses the trained weights without performing further training during normal operation, although fine-tuning variants may also be considered.

The generative AI model outputs a sequence of tokens corresponding to a prompt sentence. The server receives this output, decodes the token identifiers to text, and obtains a generated prompt sentence such as:

“Please propose new running shoes suitable for regular jogging with good cushioning.”

The server may apply post-processing to remove trailing punctuation anomalies, unify spacing, and verify that certain key categories appear in the sentence. The server may implement explicit rules, such as discarding sentences that do not include at least one product category term from a predefined taxonomy, or regenerating a prompt if the sentence exceeds a length threshold. These rules constitute non-conventional control logic that constrains the AI model outputs and ensures alignment with the internal representation data.

The server uses the prompt sentence as an intermediate artifact that separates the process of resolving user intent from the process of constructing concrete product recommendations. The server then constructs a second set of messages for the generative AI model. The server may generate a system message such as:

“You are a shopping assistant that proposes product ideas based on a prompt sentence. Provide concise, structured recommendations.”

The server may generate a user message such as:

“Prompt sentence: ‘Please propose new running shoes suitable for regular jogging with good cushioning.’ Provide three types of recommended shoes and explain their key features, without specifying brand names.”

The server sends these messages to the generative AI model. The generative AI model again executes its internal transformer layers. However, the prompt sentence now acts as a condensed and structured representation of the user's requirements, leading the attention mechanisms to focus on relevant product-related patterns in its learned parameter space. This separation of roles reduces the entropy of the input distribution seen by the model, which can improve generation stability and reduce the number of tokens needed to reach a high-quality output, thereby improving computational efficiency and latency.

The generative AI model outputs a text that describes product recommendation content, such as: “First, lightweight running shoes with high cushioning and breathable mesh uppers are recommended for daily jogging. Second, stability running shoes with firm midfoot support help maintain proper foot alignment. Third, trail running shoes with enhanced grip and protective toe caps are suitable for mixed surfaces.”

The server receives this recommendation text, parses it using text segmentation and simple pattern recognition, and constructs a structured recommendation information object that may include an array of items, each having fields such as “type_description,” “key_features,” and “usage_context.” The server may also use natural language chunking to separate sentences that correspond to different product types.

In another embodiment, the server uses the prompt sentence and at least some of the extracted feature information to query a product database or search engine. The server may convert “new running shoes suitable for regular jogging with good cushioning” into query terms and filters that correspond to internal product attributes such as “category: running_shoes,” “cushioning_level: high,” and “intended_use: daily_training.” The server executes a query against an indexed data store, such as an inverted index or a relational database with precomputed indexes. The server receives candidate product records and applies ranking algorithms, such as a weighted scoring function that combines textual relevance, sales statistics, and inventory status.

The server may then pass a subset of the structured product records to the generative AI model along with the prompt sentence to generate natural-language descriptions that are aligned with specific items. The server thus combines deterministic search results with generative explanations. This hybrid processing reduces search space and focuses the neural computation on explanation rather than retrieval, which can reduce communication overhead and model execution time.

The server stores the prompt sentence and the corresponding recommendation content as history information. The server associates the history with a user identifier or session identifier in the storage device. The server records metadata such as timestamps, input length, model parameters (for example, temperature and maximum token length), and measures of user interaction (for example, which recommendation items the user selected or expanded). The server later reads the history information to adapt preprocessing and model parameters. For example, if the server observes that the user frequently refines queries, the server may shorten prompt sentences to be more specific or may adjust temperature values to reduce variability. If the server observes that certain types of structured features lead to higher user engagement, the server may change structuring processing rules to explicitly capture those features.

The terminal receives response data that includes the product information and, optionally, an encoded form of the prompt sentence. The terminal renders the product information on the display. The terminal may organize the information in a set of cards or list items showing product types, features, and, when available, specific items retrieved from the product database. The user can scroll through the displayed information, select items of interest, and proceed to additional screens, such as detailed product pages or purchase interfaces. The terminal may also show, in a hidden or diagnostic view, the intermediate prompt sentence to system administrators or developers for debugging or quality review.

This overall architecture improves computer technology rather than merely automating a human mental process. The server implements a non-conventional sequence in which user input information is transformed into internal representation data, then into a prompt sentence, and then into recommendation content using at least two distinct invocations of a generative AI model. By separating these phases and storing the correspondence in history information, the server can adjust internal parameters and preprocessing operations to reduce latency, improve accuracy, and lower computational cost. For example, when the server detects that certain categories of requests map consistently to certain classes of prompt sentences, the server can cache prompt sentence templates or reuse intermediate representations, thereby reducing the length of messages sent to the generative AI model and decreasing network bandwidth usage and processing time.

The server further improves data management by enforcing structured internal representation data and by logging prompt-to-recommendation relationships in machine-readable form. This structure enables algorithmic analysis and optimization that would not be feasible with unstructured logs alone. The server can apply statistical analysis to the history information to identify patterns such as which internal features correlate strongly with user satisfaction or which model parameters yield lower error rates in meeting user intent. The server can then modify preprocessing, feature extraction, and parameter selection rules accordingly.

In an alternative embodiment, the server hosts a locally running generative AI model on dedicated accelerator hardware, such as graphics processing units or tensor processing units. The server stores model parameters in high-bandwidth memory and uses a model-serving framework to accept tokenized messages from the application logic. The server may implement a variant of the transformer architecture, such as a decoder-only autoregressive model that predicts the next token distribution conditioned on previous tokens. The server maintains multiple execution streams to serve concurrent requests and uses batching logic to group tokens from multiple conversations into a single matrix multiplication operation, thereby increasing throughput and improving computational efficiency.

In another variation, the server employs a smaller, distilled generative AI model for prompt sentence generation and a larger, more capable model for product recommendation content generation. The server chooses the smaller model for the first stage to reduce computational cost when clarifying user intent, and uses the larger model only when necessary for detailed recommendations. This multi-model arrangement reduces the average inference time and computing resource usage. Because the prompt sentence acts as a size-limited summary of the user's requirements, the second-stage model can operate with more constrained and predictable input length, further improving memory usage and volatility control.

The server also implements rule-based post-processing around the generative AI outputs, which constitutes additional, non-generic technical control. For example, the server may enforce a schema that limits the number of recommended items, ensures that each recommendation includes at least one explicit feature term (such as “cushioning” or “breathability”), and rejects outputs that do not meet format constraints. The server thus combines neural network computation with deterministic validation and formatting logic to produce outputs that are optimized for the terminal's user interface and for downstream integration with product databases.

The user benefits from reduced error rates and faster response times compared to systems that either rely solely on keyword-based search or invoke a generative AI model only once with raw user input. Because the server uses structured internal representation data and an intermediate prompt sentence, the system can handle ambiguous or verbose input more effectively. The attention mechanisms in the generative AI model are guided by the condensed prompt sentence, resulting in more focused computation on relevant features, and the history-based adaptation further refines performance over time. These effects yield a measurable technical improvement in the operation of the server and the terminal, including faster decoding, reduced token counts, lower network traffic, and more accurate matching between user intent and recommended product information.

In summary, the server, the terminal, and the user cooperate through concretely defined hardware and software components to implement a system that transforms natural-language user input into structured internal representation data, then into a prompt sentence, and finally into product recommendation content using a generative AI model. The system employs specific data structures, message formats, neural network architectures, and control rules that collectively improve computational efficiency, accuracy, and adaptability, and thus provide a technical advance beyond conventional abstract information processing.

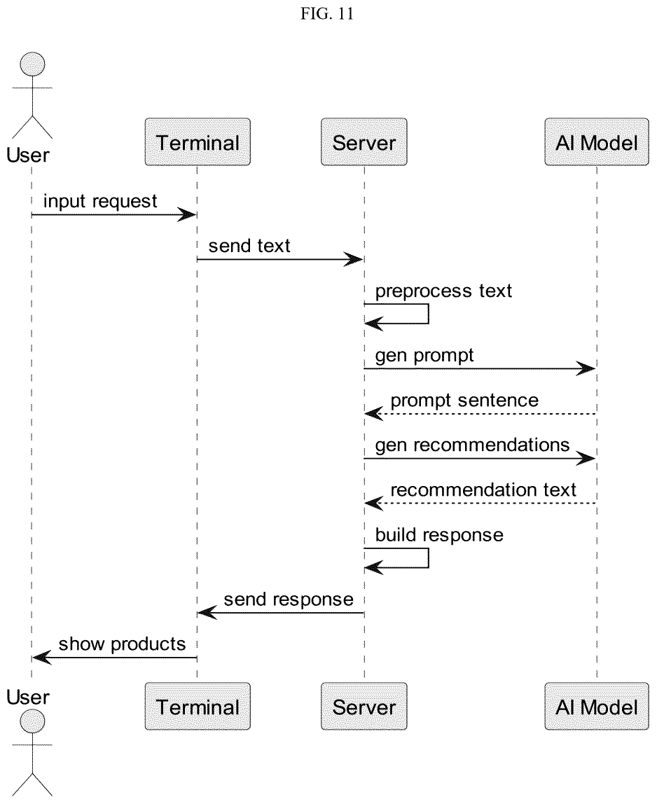

The following describes the processing flow using FIG. 11.

### Step 1

The user operates the terminal to start a communication program and to open an input screen for product-related requests. The input of this step is an empty text field displayed on the terminal, and the output is a natural-language text string entered by the user. The user types, for example, “I am looking for new running shoes” or “I am looking for cool clothes perfect for summer” using a touch keyboard or a physical keyboard. The terminal converts the keystrokes into a character string in memory and stores the string as text data in an input buffer.

### Step 2

The terminal prepares transmission data based on the text entered by the user. The input of this step is the text data contained in the input buffer, and the output is a message object to be sent to the server. The terminal adds metadata such as a user identifier and a timestamp, and it encapsulates the text data into a request structure that conforms to a predefined format. The terminal may perform simple validation, such as checking that the length of the text is greater than zero, and then it sends the request through a network interface using a communication protocol to the server.

### Step 3

The server receives the request containing the user's text. The input of this step is the transmitted message object from the terminal, and the output is an internal representation of the raw text stored in server memory. The server's network interface passes the incoming data to an application module, which decodes the message format, extracts the text string and metadata, and writes them into variables in main memory. The server may also log the raw text and metadata into a storage device for later analysis.

### Step 4

The server performs preprocessing on the received text data. The input of this step is the raw text string representing the user's request, and the output is normalized text and an internal representation data structure. The server applies character string normalization by converting all characters to a standard case, removing control characters, and standardizing spaces and punctuation. The server then applies tokenization to split the text into words or subword tokens and may attach part-of-speech tags or other linguistic labels. The server analyzes the tokens to detect feature information such as a product category (“running shoes” or “clothes”), usage context (“daily jogging” or “summer”), and constraints (“new,” “cool,” “good cushioning”). The server constructs an internal representation data structure, such as a set of key-value pairs, that stores these extracted features.

### Step 5

The server constructs messages to be input to a generative AI model for prompt sentence generation. The input of this step is the normalized text and the internal representation data structure from Step 4, and the output is a set of messages including a system message and a user message. The server generates a system message that defines the role of the model, for example: “You convert user shopping requests into a clear and concise prompt sentence for product recommendation.” The server generates a user message that embeds the original user text and the internal representation, for example: “A user wrote: ‘I am looking for new running shoes.’ The extracted features are: product category is running shoes, usage is daily jogging, and cushioning is important. Convert this into one instruction sentence to be used for product recommendation.” The server groups these messages into a request structure for the generative AI model.

### Step 6

The server invokes the generative AI model to generate a prompt sentence. The input of this step is the request structure containing the system and user messages, and the output is a generated prompt sentence in text form. The server sends the messages to an external information processing service that hosts a transformer-based generative AI model. The external service tokenizes the messages, applies embedding and positional encoding, and performs a sequence of matrix multiplications and non-linear transformations through self-attention layers. The model computes probability distributions over possible next tokens and selects tokens step by step to form a response. The server receives the generated token sequence, decodes it into a text string, and obtains a prompt sentence such as: “Please propose new running shoes suitable for regular jogging with good cushioning.”

### Step 7

The server validates and refines the generated prompt sentence. The input of this step is the raw prompt sentence produced by the generative AI model, and the output is a validated and possibly corrected prompt sentence. The server checks the length of the prompt, ensures that at least one product category term and one usage context term from the internal representation appear in the sentence, and removes unnecessary line breaks or redundant spaces. If the prompt sentence does not satisfy predefined constraints, the server may call the generative AI model again with adjusted parameters or additional instructions. The server stores the final prompt sentence in memory and, optionally, in a history store for later use.

### Step 8

The server constructs messages for generating product recommendation content based on the prompt sentence. The input of this step is the validated prompt sentence and the internal representation data, and the output is a new set of messages for the generative AI model. The server generates a system message defining a recommendation role, for example: “You are a shopping assistant that proposes product ideas based on a prompt sentence. Provide concise, structured recommendations.” The server generates a user message that includes the prompt sentence and any additional constraints, for example: “Prompt sentence: ‘Please propose new running shoes suitable for regular jogging with good cushioning.’ Provide three types of recommended shoes and explain their key features, without specifying brand names.” The server groups these messages and sets model parameters, such as a maximum number of tokens and a temperature value.

### Step 9

The server invokes the generative AI model to obtain product recommendation content. The input of this step is the message set constructed in Step 8, and the output is a text description of product recommendation content. The server sends the messages to the generative AI model, which processes the tokens through its layers and generates a sequence of tokens representing recommended product types and their features. The server receives the token sequence, decodes it into text, and obtains content such as: “Lightweight running shoes with high cushioning and breathable mesh uppers are recommended for daily jogging. Stability running shoes with firm midfoot support help maintain proper foot alignment. Trail running shoes with enhanced grip and protective toe caps are suitable for uneven surfaces.” The server stores this text in memory for further processing.

### Step 10

The server converts the product recommendation content into structured recommendation information. The input of this step is the raw recommendation text generated in Step 9, and the output is a structured data object representing recommendation information. The server applies sentence segmentation to divide the text into individual recommendation units, and it uses pattern matching or linguistic cues to identify phrases describing product types and key features. The server creates an array or list of recommendation items, and each item may include fields such as “type_description,” “feature_list,” and “usage_context.” The server may further align these fields with the internal representation data to ensure consistency.

### Step 11

The server optionally queries a product data store using the prompt sentence and the structured recommendation information. The input of this step is the prompt sentence, the internal representation data, and the structured recommendation items, and the output is a set of concrete product records. The server constructs search conditions, such as category filters and attribute filters, from the prompt sentence and the internal features. The server sends a query to a database or search engine, which returns product records that match the conditions. The server ranks the results based on relevance scores or business rules and associates a subset of the records with corresponding recommendation items to form enriched recommendation information.

### Step 12

The server constructs response data to be sent to the terminal. The input of this step is the structured recommendation information and any associated product records, and the output is a response object formatted for transmission. The server assembles product information that includes product category information, product attribute information, and explanatory text derived from the recommendation content. The server assigns identifiers and organizes the information into a structure suitable for display, such as a list of items with titles and descriptions. The server then encapsulates this structure in a response format and writes it into an output buffer in memory.

### Step 13

The server updates history information that links the prompt sentence and the recommendation content. The input of this step is the prompt sentence, the generated recommendation content, and, optionally, metadata such as timestamps and model parameters, and the output is updated history data stored in a storage device. The server creates or updates a history record that contains the correspondence between the prompt sentence and the recommendation outcomes, and the server indexes this record by a user identifier or a session identifier. The server uses this stored history in later sessions to adjust preprocessing operations or model parameters, for example by modifying thresholds or feature extraction rules for similar future inputs.

### Step 14

The server transmits the response data to the terminal. The input of this step is the response object in the server's output buffer, and the output is a transmitted message arriving at the terminal. The server uses the network interface and the communication protocol to send the response across the communication network. The server sets appropriate headers and control parameters to indicate successful processing. The server may also include session tokens or control flags that instruct the terminal how to display or cache the received information.

### Step 15

The terminal receives the response data from the server and prepares it for display. The input of this step is the transmitted message containing the product information, and the output is a display-ready data structure in the terminal's memory. The terminal decodes the message format, extracts the list of recommendation items and any associated product records, and maps the data fields to user interface components. The terminal arranges the items in a scrollable list or grid, with text labels and optional image placeholders. The terminal may also store the received data locally for offline viewing or for providing quick access to recent recommendations.

### Step 16

The user views and interacts with the displayed product information. The input of this step is the visual rendering of the product information on the terminal's display, and the output is user interaction events, such as taps, scrolls, or selections. The user reads the descriptions of recommended product types, compares features such as cushioning, weight, or breathability, and may select specific items for more details. The user's actions generate event data that the terminal captures and may send back to the server in subsequent requests. The user may input follow-up requests or clarifications, which become new text data that initiate another cycle beginning at Step 1.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional product recommendation techniques implemented on information processing systems typically rely on fixed rule sets, manually designed recommendation logic, or simple collaborative filtering that operates on coarse user segments. Such approaches suffer from several technical limitations. First, they often process user request text and user history information in isolation, such that the system cannot dynamically construct an accurate, context-rich representation of a specific user session. As a result, the internal data structures used by the server, such as request objects and recommendation queries, are poorly aligned with the actual content of the user's natural-language input and the detailed user history stored in databases.

Second, in many existing systems, the server directly applies a generative AI model or a machine learning model to raw user input without generating a structured and explicitly constrained prompt sentence. This often leads to output that is noisy, difficult to parse, and not directly mappable to concrete product records stored in a product database. The server must then perform ad hoc text parsing and heuristic filtering, which increases processing complexity and latency, and degrades the determinism and reproducibility of the recommendation pipeline.

Third, conventional architectures do not tightly integrate the generative AI model's output with the server's internal catalog search and ranking mechanisms. The generative AI model may generate descriptions of hypothetical products or products that do not correspond to entries in the product catalog. The server may therefore be forced to either discard useful generative output or to present recommendations that are not actually available for purchase, which diminishes system reliability, user trust, and the effective use of hardware and software resources.

Fourth, many existing implementations do not provide a generic and reusable mechanism by which the server can transform high-level, unstructured user requests and heterogeneous history data into a consistent prompt sentence format. This limits the ability of the system to scale across different product domains and user interfaces, and prevents efficient optimization of server-side data processing, such as caching, logging, and performance tuning.

Accordingly, there is a need for an improved computer-implemented technique that, within a server, systematically acquires user request text from a user terminal, integrates the text with user history information and preference information into structured user attribute information, constructs a well-defined prompt sentence for a generative AI model based on a template, and then converts the model's output into product candidate information that can be reliably aligned with actual product information stored in a product information storage unit. Such a technique should improve the internal data flow and control flow in the server, reduce the computational overhead for post-processing generative output, and enhance the accuracy, consistency, and responsiveness of product recommendation presented on the user terminal.

The specific processing by the specific processing unit 290 of the data processing device 12 in Application Example 1 is realized by the following means.

The present invention provides a server comprising a processor configured to acquire, via a communication unit, text information including user request information from a user terminal; to acquire user history information and preference information stored in a storage unit, and to integrate the user history information and the preference information with a request content based on the text information to generate user attribute information; to construct, based on template information, an instruction sentence for input to a generative information processing model by using the user attribute information and the text information, and to generate the instruction sentence as a prompt sentence; to input the prompt sentence to the generative information processing model, to execute natural language processing by the generative information processing model, and to extract product candidate information from output information of the generative information processing model; to compare attributes included in the product candidate information with product information stored in a product information storage unit, to select product candidates in consideration of the user history information and the preference information, and to generate product information to be proposed to a user; and to generate response information for transmitting the product information to the user terminal via the communication unit. This enables the server to implement an improved, computer-centric recommendation pipeline in which user-specific context is algorithmically transformed into a structured prompt sentence, generative model output is converted into machine-tractable product candidate data, and such data is reliably reconciled with catalog product records, thereby enhancing the efficiency, scalability, and technical performance of the underlying information processing system.

The term “processor” refers to a hardware computation unit, such as a central processing unit or an execution core, that is capable of executing instructions of a program to perform logical operations, arithmetic operations, control operations, and data transfer operations within the server.

The term “communication unit” refers to a hardware and software combination, such as a network interface controller and communication control program, that enables the server to transmit and receive data to and from an external device via a communication network.

The term “user terminal” refers to an external information processing apparatus, such as a portable information device or a general-purpose computing device, that is operated by a user and configured to exchange information with the server through the communication network.

The term “text information” refers to data expressed as a sequence of characters or symbols in a natural language or a structured language, including at least a part that represents a user request or query, which is transmitted from the user terminal to the server.

The term “user request information” refers to a subset of the text information that explicitly or implicitly indicates a desired product, condition, preference, constraint, or question presented by the user.

The term “storage unit” refers to a memory device, such as a semiconductor storage device or a magnetic storage device, that stores data including user history information, preference information, product information, template information, and program code in a non-transitory manner or a temporarily stored manner.

The term “user history information” refers to data representing past behavior of the user, including at least one of purchase records, browsing records, search records, evaluation records, and interaction records between the user and the server.

The term “preference information” refers to data representing a tendency or inclination of the user with respect to attributes such as category, brand, price range, color, size, style, or function of a product, which is derived from the user history information or explicitly provided by the user.

The term “request content” refers to an interpreted representation of the user request information extracted from the text information, including identified product categories, conditions, constraints, and contextual parameters relevant to recommendation processing.

The term “user attribute information” refers to structured data generated by integrating the request content with the user history information and the preference information, representing a profile of the user and the current request in a form suitable for machine processing.

The term “template information” refers to data defining a pattern, format, or schema for constructing an instruction sentence, the pattern including fixed text portions and variable insertion positions for user attribute information and text information.

The term “instruction sentence” refers to a piece of text or a sequence of tokens that expresses a machine-readable command or request, which is configured to be input to a generative information processing model to cause the generative information processing model to execute a specific processing task.

The term “prompt sentence” refers to an instruction sentence generated based on the template information, the user attribute information, and the text information, and provided as an input to the generative information processing model to control behavior of the generative information processing model.

The term “generative information processing model” refers to a trained machine learning model, such as a neural network model, that performs natural language processing and generates output information in response to input information including a prompt sentence.

The term “natural language processing” refers to processing in which the generative information processing model analyzes, interprets, or generates information represented in a human language by performing operations such as tokenization, embedding, transformation, and decoding.

The term “output information of the generative information processing model” refers to data produced by the generative information processing model when the prompt sentence is input, the data including at least one of generated text, structured data, and explanatory information.

The term “product candidate information” refers to data extracted from the output information of the generative information processing model, the data including at least one candidate item with attributes such as product name, category, feature, price range, or reason for recommendation.

The term “product information storage unit” refers to a storage unit or a logical storage area that stores product information, including product identifiers, attributes, prices, availability, and resource locations associated with products handled by the system.

The term “product information” refers to data describing a product or service, including at least one of a product identifier, designation, category, specification, attribute, price, stock status, image reference, and purchase reference.

The term “attributes included in the product candidate information” refers to items of data, such as category, function, price level, size, or color, which characterize each product candidate and are used for comparison with corresponding attributes in the product information.

The term “product candidates” refers to one or more products selected from product information on the basis of the product candidate information and the user attribute information as products presumed to be suitable for the user.

The term “product information to be proposed to a user” refers to product information that has been selected as product candidates and has been determined, based on the user history information and the preference information, to be presented to the user through the user terminal.

The term “response information” refers to data generated by the processor and transmitted to the user terminal via the communication unit, the data including at least part of the product information to be proposed and optionally explanation information or control information for presentation.

The term “communication application” refers to a software component executed by the communication unit or in cooperation with the communication unit, which controls data exchange over the network, and handles transmission and reception of structured data including the text information and the product information.

The term “structured data” refers to information organized in a predefined format, such as a key-value format, a table format, or a markup format, thereby enabling programmatic parsing, validation, and processing by the server and the user terminal.

The term “display control information” refers to data representing how product information and explanation information should be arranged, formatted, or emphasized on a display device, including layout parameters, ordering, grouping, and visual attribute parameters.

The term “display device of the user terminal” refers to a visual output apparatus, such as a liquid crystal display or an organic light emitting display, that presents information to the user under control of a processing unit of the user terminal.

The term “explanation information generated by the generative information processing model” refers to descriptive data, included in or derived from the output information of the generative information processing model, that explains characteristics, advantages, or reasons for recommendation of a product candidate.

In one embodiment, a server implements the claimed system by executing a program on a processor that cooperates with a communication unit, a storage unit, and a product information storage unit. The server is connected via a communication network to a plurality of user terminals, each user terminal being, for example, a smartphone, a tablet, or a personal computer including a display device, an input device, and a local communication interface.

The server uses general-purpose hardware such as a multicore central processing unit, a main memory device, a non-volatile storage device, and a network interface controller. The server executes an operating system and middleware including a web server process, an application server process, and a database management process. The user terminal uses hardware such as a central processing unit, a memory device, a display panel, and a wireless or wired network adapter, and executes a client program such as a web browser or a dedicated communication application.

The server uses a communication application implemented on the application server to control data exchange with the user terminal. The communication application is realized by a web framework or an application framework and operates on the server to receive text information including user request information, and to transmit product information and explanation information. The communication application uses a structured data format such as a key-value structure transmitted over a transport protocol. The server thereby reduces unnecessary protocol overhead by consolidating multiple user attributes and request parameters into a single message structure, which improves communication efficiency.

The server stores, in the storage unit, user history information, preference information, template information, and program instructions. The storage unit includes a relational data store or a key-value data store. The server further stores, in the product information storage unit, product information including identifiers, attributes, and resource pointers for a plurality of products. The server maintains internal data structures such as a user profile record, a session context record, a prompt context record, and a product candidate record. Each record includes fields for user identifiers, attribute vectors, request category tags, budget ranges, size values, color preferences, and other attributes.

The server acquires text information including user request information from the user terminal through the communication unit. The server parses the text information using a natural language preprocessing routine that executes on the processor. The server uses tokenization, part-of-speech tagging, and entity extraction algorithms implemented by a natural language processing library to identify tokens, syntactic boundaries, and semantic entities. The server maps expressions such as “lightweight,” “summer,” “under 100 dollars,” and “running shoes” to normalized attribute values, such as a weight preference flag, a season tag, a budget range, and a product category tag. The server stores the normalized values in the session context record.

The server retrieves user history information and preference information associated with the user identifier from the storage unit. The server executes database queries or key-based retrieval operations to obtain records representing past purchases, viewed items, and explicit ratings. The server aggregates this information by computing statistics such as frequency counts of categories, average price ranges, most frequently purchased sizes, and most frequently selected colors. The server generates preference information in the form of a compact attribute vector, for example by assigning a numeric value to each category, brand group, price band, and size cluster. The server stores this attribute vector in the user profile record and links it to the current session context.

The server integrates the user history information, the preference information, and the request content obtained from the text information to generate user attribute information. The server uses a predetermined data schema in which each attribute is encoded as a numeric value, a categorical code, or a text descriptor. The server uses feature engineering rules implemented in the application logic to combine request-derived constraints with history-derived tendencies. For instance, the server may override a default budget inferred from history when the request expresses an explicit maximum budget. The server thereby generates a structured set of user attribute information that directly corresponds to features expected by a downstream prompt construction routine.

The server constructs an instruction sentence for input to a generative information processing model by using the user attribute information and the text information. The server uses template information stored in the storage unit, where the template information defines fixed sentence segments and placeholder segments for attribute insertion. The server performs string concatenation operations, variable substitution operations, and format-control operations to generate a complete text string serving as a prompt sentence. The server thereby ensures that each prompt sentence includes, in a consistent order, a description of the user's current request, a summary of preferences, a budget constraint, and a required output format.

In one concrete example, the server generates the following prompt sentence:

“The user has requested: ‘I am looking for lightweight running shoes for summer.’ The user's preferred shoe size is 26.5. The preferred brands are a first brand group and a second brand group. The preferred colors are blue and white. The approximate budget is up to 100 units of currency. Based on this information and considering the user's past purchase history, please recommend 5 suitable running shoe models. For each model, output: (1) product name, (2) short description, (3) key features with focus on breathability and light weight, (4) approximate price, and (5) a brief explanation of why this model is a good fit for the user.”

The server inputs the prompt sentence to a generative information processing model. In one embodiment, the generative information processing model is a neural network model adopting a transformer architecture. The model includes an embedding layer that transforms each token of the prompt sentence into a high-dimensional numeric vector, a plurality of transformer blocks each including a multi-head self-attention mechanism and a feedforward network, and a decoding layer that outputs a probability distribution over a vocabulary. The model parameters include weight matrices and bias vectors stored in a model parameter store. The model executes attention score computations, vector multiplications, non-linear activation operations, and softmax computations for each layer.

The server sends the prompt sentence to the generative information processing model via an inference interface. The inference interface may reside on the same server or on a separate computation resource. The server transmits the prompt sentence as a sequence of tokens or as plain text, and receives output information as a generated text sequence. The generative information processing model processes the prompt sentence by repeatedly selecting next tokens based on the calculated probability distribution, thereby generating explanatory text that describes candidate products, their features, their approximate prices, and reasons for recommendation. The model uses an attention mechanism that gives higher weights to tokens corresponding to explicit constraints such as “summer,” “lightweight,” and “budget,” and to tokens representing user preference attributes. This attention mechanism causes the generated output to reflect the combined effect of the user's current request and historical profile, which differs from conventional keyword-only recommendation engines.

The server extracts product candidate information from the output information of the generative information processing model. The server analyzes the generated text by applying a parsing routine tailored to the expected structure of the prompt sentence. For instance, the server searches for numbered segments or key phrases marking product names, feature lists, and reasons. The server splits the text into candidate entries and maps each entry to a product candidate record in an internal data structure. The server normalizes attributes such as product category, implied price level, and key features into machine-readable fields. By constraining the output format through the prompt sentence and by performing deterministic parsing, the server reduces ambiguity and error in interpreting free-form generative output.

The server compares attributes included in the product candidate information with product information stored in the product information storage unit. The server executes search queries against an index built over the product information, where the index includes inverted lists for textual attributes and numeric indexes for categorical codes and numeric ranges. The server generates query vectors from candidate attributes, such as feature keywords and category tags, and compares them with precomputed product vectors using similarity measures. The server optionally uses a secondary scoring model that evaluates the relevance between candidate attributes and actual product attributes. The server thereby associates each generated candidate with one or more actual products that exist in the product catalog.

The server selects product candidates in consideration of the user history information and the preference information. The server calculates a ranking score for each product candidate by combining similarity scores between candidate attributes and product attributes with preference scores derived from the user profile, such as a weight for preferred brands or a penalty for disfavored colors. The server may also apply constraints such as budget constraints or availability checks. The server then selects a subset of product candidates having highest ranking scores as product information to be proposed to the user. Because the server uses numeric ranking and constraint application, the selection process is not a mere one-to-one mapping from generative output but an additional computation layer that improves consistency with the actual catalog.

The server generates response information for transmitting the product information to the user terminal. The server converts internal product records into a structured format that includes product names, descriptions, prices, resource locators, and textual explanations derived from the product candidate information. The server may compress the response structure by omitting redundant fields or by using compact identifiers, thereby reducing communication load. The server then transmits the response information via the communication unit to the user terminal.

The user terminal receives the response information and uses its local processor and display device to present the recommended products to the user. The user terminal renders, on the display device, a list of product candidates including names, prices, and explanation information extracted from the output of the generative information processing model. The user can select products, request further refinement, or initiate a purchase procedure. When the user inputs additional constraints through the input device, the user terminal transmits new text information to the server, and the server repeats the processing using updated request content.

This configuration provides technical effects that go beyond mere automation of human mental work. By generating user attribute information in a standardized feature representation and by constructing prompt sentences according to a predetermined template, the server is able to exploit the structure of the generative information processing model more efficiently. The server avoids repeatedly transmitting large volumes of raw history data and instead transmits only an abstracted context description. This reduces communication bandwidth and decreases latency between the server and the generative information processing model.

Moreover, by constraining the generative output through structured prompt sentences and by using deterministic parsing routines, the server decreases error rates in mapping generated descriptions to actual products. This reduces the number of failed lookups and improves cache hit rates in the product information storage unit. The server can precompute indexes and vector representations that anticipate the shape of prompt-induced outputs, which results in faster search and retrieval operations compared to systems that handle unstructured text with ad hoc processing.

In addition, the server improves computational efficiency by separating operations into clearly defined modules: a preprocessing module that generates user attribute information, a prompt generation module that constructs the prompt sentence, an inference module that interacts with the generative information processing model, and a postprocessing module that aligns candidate information with the product catalog. Each module uses specific data structures designed for efficient access patterns, such as contiguous arrays for attribute vectors and hash maps for product identifiers. As a result, the server can parallelize parts of the pipeline, making better use of multicore processor resources and reducing end-to-end response time.

The generative information processing model itself is trained, prior to deployment, using supervised learning and reinforcement techniques on corpora containing product descriptions, user queries, and explanation texts. The training process uses a loss function that includes cross-entropy between predicted and reference tokens, and may further include additional regularization terms to encourage structured outputs. A gradient-based optimization algorithm such as stochastic gradient descent with momentum or adaptive moment estimation updates the weight parameters. Data augmentation techniques, such as paraphrase generation and synonym substitution, increase the diversity of training prompts and outputs, enabling the model to handle a wide variety of user expressions without degradation in accuracy.

The server benefits from this training method in that the generative information processing model tends to produce outputs that adhere to the requested structure when the prompt sentence specifies numbered lists or explicit output fields. This cooperation between the server's template-based prompt generation and the model's internal training results in reduced post-processing logic and reduced need for complex heuristic parsing. Consequently, the server achieves improved overall reliability and consistency in recommendation behavior.

The server implements non-conventional processing rules that differ from simple business logic. For example, when the user requests a product category that is rarely purchased in the past, the server may adjust the weights applied to history-derived preferences so that the generated prompt sentence emphasizes current constraints more strongly. The server thereby avoids overfitting to historical behavior, which is a problem in traditional collaborative filtering systems, and dynamically balances history and current intent using algorithmic rules. This approach is specifically designed to drive the generative information processing model toward generating relevant candidate descriptions for new product categories, thus improving recommendation accuracy in cold-start or exploratory scenarios.

In another embodiment, the server uses alternative template arrangements or different generative information processing models, such as models with different numbers of layers or attention heads. The server may also adopt different similarity metrics in the postprocessing module, or may incorporate an additional classifier that filters out candidates that do not meet predefined quality thresholds. In any case, the fundamental structure remains that the server generates user attribute information from combined history and request data, constructs a structured prompt sentence based on template information, obtains candidate descriptions from a generative information processing model, and aligns those descriptions with actual product information.

In yet another embodiment, the server may reside in a distributed computing environment where different modules run on different physical machines or virtual instances. For example, the prompt generation module and the product catalog alignment module may operate on separate servers, and a load balancer may distribute incoming requests. The communication unit in this case coordinates inter-module data exchange using internal network protocols. This distributed configuration enables horizontal scaling and provides improved throughput for high-traffic environments while preserving the same technical improvements in data handling, accuracy, and latency.

By providing these specific structures, data formats, and algorithmic interactions between the server, the generative information processing model, and the user terminal, the system improves computer-centric aspects of product recommendation processing. The server reduces computational waste, enforces predictable data flows, and leverages a generative AI model under explicit control of a prompt sentence construction mechanism. This integrated design yields measurable improvements in processing speed, selection precision, and resource utilization compared to conventional rule-based or unconstrained generative systems.

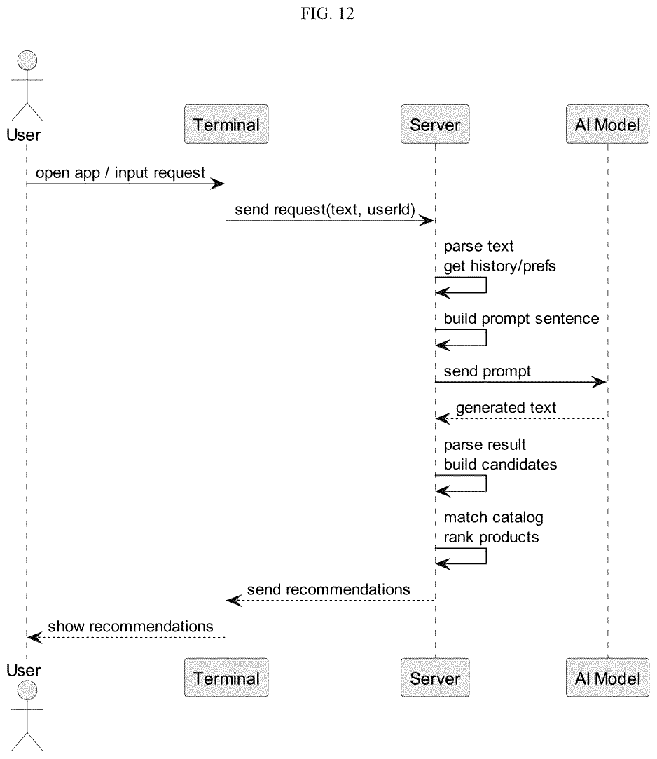

The following describes the processing flow using FIG. 12.

### Step 1

The user operates the terminal to launch a communication application and to input request text.

The input of this step is user keystrokes or touch inputs representing a product request, such as “I am looking for lightweight running shoes for summer under 100 dollars.”

The terminal converts the keystrokes into a character string in memory, encapsulates the string together with a user identifier and session identifier into a structured message, and displays the entered text on the screen for confirmation.

The output of this step is a structured request message stored in the terminal's memory, ready to be transmitted to the server.

### Step 2

The terminal transmits the structured request message to the server via the communication network.

The input of this step is the structured request message generated in Step 1.

The terminal uses its network interface and a communication protocol implementation to serialize the structured message into a transmission format, attach necessary headers including authentication tokens, and send the message to a preconfigured server endpoint.

The output of this step is a network packet stream containing the request message delivered to the server.

### Step 3

The server receives the request message through the communication unit and decodes the structured data.

The input of this step is the network packet stream arriving from the terminal.

The server uses a communication stack to reassemble packets into a complete message, parses the headers, and deserializes the body into internal objects containing fields such as user identifier, raw text information, timestamp, and device information.

The output of this step is a request object stored in server memory and, optionally, a persisted record in a request log storage.

### Step 4

The server retrieves user history information and preference information associated with the user identifier from the storage unit.

The input of this step is the request object including the user identifier.

The server issues database queries or key-based lookups to obtain records for past purchases, browsing events, ratings, and explicit preference settings, and it loads these records into internal data structures such as arrays or hash maps.

The output of this step is a set of user history records and preference records residing in server memory.

### Step 5

The server analyzes the text information of the current request and normalizes request-related attributes.

The input of this step is the raw request text from the request object and any metadata such as language code.

The server applies tokenization and entity extraction algorithms to split the text into tokens, identify product category terms, budget expressions, temporal expressions (such as season), and qualitative adjectives (such as lightweight), and then converts these entities into normalized codes and numeric values.

The output of this step is a request feature set that encodes the request content as structured attributes, including category tags, maximum budget value, season flag, and feature flags.

### Step 6

The server integrates the request feature set with the user history information and the preference information to generate user attribute information.

The input of this step is the request feature set from Step 5 and the user history and preference records from Step 4.

The server executes aggregation and weighting operations, such as computing weighted averages of price levels, merging preferred brands with currently requested brands, and resolving conflicts between default size preferences and explicitly requested sizes, to produce a unified attribute vector or structured profile object.

The output of this step is user attribute information that represents the combined and reconciled state of the user's historical tendencies and current request constraints.

### Step 7

The server constructs a prompt sentence for a generative AI model by applying template information to the user attribute information and the original text information.

The input of this step is the user attribute information from Step 6, the raw request text from Step 3, and a prompt template stored in the storage unit.

The server executes string formatting operations, replaces placeholder tokens in the template with concrete values such as preferred size, budget, and color preferences, and concatenates multiple text segments in a prescribed order to form a coherent instruction sentence.

The output of this step is a completed prompt sentence, for example: “The user has requested: ‘I am looking for lightweight running shoes for summer under 100 dollars.’ The user's preferred shoe size is 26.5. The preferred brands are a first brand group and a second brand group. The preferred colors are blue and white. The approximate budget is up to 100 units of currency. Based on this information and considering the user's past purchase history, please recommend 5 suitable running shoe models. For each model, output: (1) product name, (2) short description, (3) key features with focus on breathability and light weight, (4) approximate price, and (5) a brief explanation of why this model is a good fit for the user.”

### Step 8

The server submits the prompt sentence to a generative AI model and obtains generated output information.

The input of this step is the prompt sentence from Step 7.

The server uses an inference interface to convert the prompt sentence into a sequence of tokens, sends the tokens or text to the generative AI model, and receives a generated text sequence as a response. Within the model, embedding operations, attention calculations, and decoding operations are applied, but from the server's perspective the processing consists of forming a request object, transmitting it, and reading back the generated text.

The output of this step is model output information containing recommended product descriptions and explanation text in natural language.

### Step 9

The server parses the generated output information to extract product candidate information.

The input of this step is the natural-language response from the generative AI model.

The server applies pattern recognition routines, such as splitting by numbered list markers or delimiter phrases, and then extracts fields such as candidate product name, feature description, approximate price, and reason for recommendation. The server converts these fields into structured records by trimming extraneous text, normalizing price values, and mapping feature words to predefined feature codes.

The output of this step is an array or list of product candidate records, each record containing structured attributes derived from the model output.

### Step 10

The server aligns each product candidate record with actual product information stored in the product information storage unit.

The input of this step is the list of product candidate records from Step 9 and the product information in the product information storage unit.

The server generates search queries from candidate attributes, such as category, feature codes, and price ranges, and executes these queries against an index of catalog products. The server calculates similarity scores between candidate attributes and catalog attributes using numerical comparisons, keyword matching, or vector similarity calculations, and selects one or more catalog entries that best match each candidate.

The output of this step is a list of aligned product records where each candidate record is linked to at least one actual product entry including identifiers, exact prices, and resource locators.

### Step 11

The server ranks and filters the aligned product records by taking into account user history information and preference information.

The input of this step is the aligned product records from Step 10 and the user attribute information from Step 6.

The server computes a ranking score for each aligned product by combining similarity scores with preference weights, budget conformity indicators, and availability status, and then sorts the products in descending order of the ranking score while discarding products that violate mandatory constraints such as maximum budget or size incompatibility.

The output of this step is an ordered list of recommended products selected as product information to be proposed to the user.

### Step 12

The server generates response information for the terminal, including structured product information and explanation information.

The input of this step is the ordered list of recommended products from Step 11.

The server transforms each recommended product into a response element containing fields such as product name, short description, price, image reference, product link, and explanatory text, and then aggregates the elements into a response payload. The server may compress or encode the payload and attach necessary metadata such as pagination information and tracking identifiers.

The output of this step is a response payload ready for transmission to the terminal.

### Step 13

The server transmits the response payload to the terminal through the communication unit.

The input of this step is the response payload from Step 12.

The server serializes the payload into the selected transmission format, attaches transport headers, and sends the data across the communication network using the established connection with the terminal, monitoring for transmission errors and, if necessary, retrying failed transmissions.

The output of this step is a stream of response data arriving at the terminal.

### Step 14

The terminal receives the response data and reconstructs the list of recommended products for presentation.

The input of this step is the response data stream from Step 13.

The terminal uses its communication stack to reconstruct the complete payload, deserializes the structured data into internal objects, and validates the contents, such as checking for missing fields or malformed values, before passing the objects to the display logic.

The output of this step is a structured representation of recommended products stored in the terminal's memory.

### Step 15

The terminal renders the recommended products on the display device for the user.

The input of this step is the structured representation of recommended products from Step 14.

The terminal generates graphical user interface elements such as product cards, loads images from the referenced locations, and arranges text fields including product name, price, and explanatory text according to a layout definition, then outputs the composite image frames to the display device.

The output of this step is a visual display on the terminal screen showing the recommended products in a form that the user can view and interact with.

### Step 16

The user views the displayed recommendations and optionally inputs additional constraints or selection commands.

The input of this step is the visual display from Step 15 and any user intention regarding refinement or selection.

The user operates the input device of the terminal to select a product, scroll through the list, or enter new text such as “show cheaper options” or “I prefer black color,” and the terminal captures these interactions as new request parameters or commands.

The output of this step is new user input data in the terminal, which can be forwarded again to the server as a new or updated request message, thereby re-initiating the processing flow starting from Step 1 or Step 2.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional product recommendation systems generally rely on fixed rule-based engines or simple statistical models that operate on limited sets of user attributes. Such systems often treat user input text merely as keywords and perform only superficial matching against product catalogs. As a result, these systems are unable to accurately capture nuanced user intent, contextual constraints such as budget or usage scene, or latent user preferences inferred from past purchase and browsing behavior. Consequently, the precision and personalization level of recommended products remain insufficient, which leads to lower conversion rates and diminished user satisfaction.

Furthermore, in many existing architectures, user behavior data retrieval, natural language understanding, recommendation generation, and downstream transaction processing are implemented as loosely coupled or separate subsystems. This fragmented design requires multiple integrations and ad hoc interfaces and increases processing latency, resource consumption, and failure points. In particular, when large-scale generative artificial intelligence models are used externally to generate recommendation content, the lack of a systematic mechanism for constructing prompt sentences from structured user behavior data and intent information results in unstable output quality, inconsistent recommendation formats, and increased need for manual post-processing.

In addition, conventional systems typically stop at presenting recommended products and do not tightly integrate the recommendation workflow with subsequent e-commerce operations, such as order generation, payment processing, packaging instruction generation, message creation for gift scenarios, and shipping instruction control. This separation forces the user to perform multiple additional operations across different applications or subsystems, increases the likelihood of input errors or dropped transactions, and prevents end-to-end optimization of the user experience from product discovery to fulfillment.

From the standpoint of computer technology, there is a need for an improved server-side architecture and processing method that: (i) systematically acquires and aggregates user behavior history at scale; (ii) performs natural language understanding on free-form user input to derive machine-usable intent and constraints; (iii) automatically constructs structured prompt sentence data for a generative information processing model using both user preference information and intent information, and optionally distribution trend information; and (iv) integrates the generative model's output with product information retrieval and transaction management in a unified processing pipeline. Such an architecture should reduce processing latency, improve computational resource utilization, stabilize the quality and structure of generated recommendations and messages, and provide a technically improved, end-to-end computer-implemented solution compared to conventional disjoint systems.

The specific processing by the specific processing unit 290 of the data processing device 12 in Example 2 is realized by the following means.

The present invention provides a server comprising a processor configured to acquire, via a communication network, character information regarding a product and user identification information from a user terminal operated by a user; to acquire, based on the user identification information, purchase history information and browsing history information of the user from a behavior history information storage device, perform aggregation processing and tendency extraction processing on the purchase history information and the browsing history information for each attribute, and generate user preference information; to perform semantic analysis processing on the acquired character information using a natural language processing unit, and extract product type information, constraint condition information, and user intention information; to generate prompt sentence data including explanation information, condition information, and output format information for configuring a prompt sentence to be input to a generative information processing model, based on the user preference information and the user intention information and, in some embodiments, additionally based on distribution trend information and popularity information stored in a product category information storage device; to input the prompt sentence data to the generative information processing model and acquire generated result data including product proposal information from the generative information processing model; to search a product information storage device based on product attribute information included in the generated result data, generate product candidate information to which inventory information, price information, and display explanation information are added, and transmit the product candidate information as individualized proposal information to the user terminal; and to generate order information based on purchase operation information acquired from the user terminal, and control a settlement processing unit, a packaging instruction unit, a message information generation unit, and a delivery instruction unit to execute processing from purchase to shipment, including, in certain embodiments, generating additional prompt sentence data for the generative information processing model to create gift message information and associating such message information with the order information. This enables an integrated, computer-implemented recommendation and transaction processing pipeline in which user behavior history analysis, natural language understanding, prompt sentence generation for a generative AI model, product candidate retrieval, and e-commerce fulfillment operations are executed in a coordinated manner by the server, thereby improving recommendation relevance, stabilizing the structure and quality of generative outputs, reducing processing latency and interface overhead between subsystems, and enhancing overall system performance and user experience compared to conventional systems.

The term “processor” refers to a hardware information processing unit, such as a central processing unit or an equivalent computing unit, configured to execute instructions stored in a memory to perform various data acquisition, analysis, generation, and control operations.

The term “communication network” refers to a wired or wireless data communication infrastructure, such as the Internet or a local area network, that enables data exchange between the server and a user terminal or between the server and external devices or services.

The term “user terminal” refers to an information processing device operated by a user, such as a mobile communication device, a tablet device, a personal computer, or an equivalent device, that can transmit and receive data to and from the server via the communication network.

The term “character information” refers to digital text data representing user input, including keywords, phrases, sentences, or other textual expressions regarding a product, an intention, or a constraint.

The term “user identification information” refers to data that uniquely or pseudo-uniquely identifies a user within the system, such as a user ID, an account ID, or equivalent identification data.

The term “behavior history information storage device” refers to a data storage apparatus or storage subsystem, such as a database system or a file storage system, configured to store history information relating to user behavior, including purchase history information and browsing history information.

The term “purchase history information” refers to data indicating past transactions of products or services by a user, including at least a product identifier, a purchase time, and optionally one or more attributes such as a category, a price, a brand, or a quantity.

The term “browsing history information” refers to data indicating past viewing or access behavior of a user in relation to products or content, including at least a product identifier or content identifier and a viewing time, and optionally one or more attributes such as a category or an access source.

The term “aggregation processing” refers to data processing that combines multiple behavior history records according to one or more attributes, such as category, price range, or brand, to compute statistical values such as counts, averages, or distributions.

The term “tendency extraction processing” refers to data analysis processing that derives patterns, preferences, or trends from behavior history information, such as identifying frequently purchased categories, preferred price ranges, or dominant attributes over time.

The term “user preference information” refers to data generated from purchase history information and browsing history information by aggregation processing and tendency extraction processing, indicating inferred preferences of a user, such as preferred product categories, price ranges, or attribute tendencies.

The term “natural language processing unit” refers to a software or hardware module configured to perform natural language analysis on character information, including processing such as tokenization, part-of-speech tagging, syntactic parsing, or semantic analysis.

The term “semantic analysis processing” refers to natural language analysis that interprets the meaning of character information, including extracting entities, intents, constraints, and other semantic elements from user input text.

The term “product type information” refers to data indicating a type or category of a product derived from user input or analysis results, such as a clothing category, an electronics category, or other abstracted classification information.

The term “constraint condition information” refers to data indicating one or more conditions or limitations specified or implied by the user, such as a budget limitation, a recipient attribute, a usage scenario, or a temporal condition.

The term “user intention information” refers to data indicating a purpose or objective of the user derived from semantic analysis processing, such as a request to search for products, a request to select a gift, or a request to obtain recommendations under specified conditions.

The term “prompt sentence data” refers to structured information representing a prompt sentence or a group of prompt sentences to be input to a generative information processing model, including explanation information, condition information, and output format information.

The term “explanation information” refers to a portion of the prompt sentence data that explains context, background, or user-related information, such as user preference information, past behavior summaries, or scenario descriptions, to the generative information processing model.

The term “condition information” refers to a portion of the prompt sentence data that specifies constraints or requirements to be applied by the generative information processing model, such as budget constraints, category restrictions, trend conditions, or quantity limits.

The term “output format information” refers to a portion of the prompt sentence data that indicates how the generative information processing model should format its output, such as specifying list structures, field names, or requirements for structured data representation.

The term “generative information processing model” refers to a machine learning model, such as a generative artificial intelligence model, configured to generate text or other information in response to input prompt sentence data, based on learned parameters.

The term “generated result data” refers to data output from the generative information processing model in response to prompt sentence data, including at least product proposal information and optionally additional descriptive or structured information.

The term “product proposal information” refers to information indicating candidate products recommended to the user, including at least product types or attributes, and optionally reasons for recommendation, usage suggestions, or message suggestions.

The term “product attribute information” refers to data indicating one or more characteristics of a product, such as a category, a price, a color, a size, a brand, or other specification attributes.

The term “product information storage device” refers to a data storage apparatus or storage subsystem configured to store product information, including product identifiers, product attribute information, inventory information, and price information.

The term “product candidate information” refers to information indicating one or more specific products selected based on product attribute information from the product information storage device, to which inventory information, price information, and display explanation information are added.

The term “inventory information” refers to data indicating availability of a product, such as stock quantity, stock status, or warehouse location information.

The term “price information” refers to data indicating a monetary value associated with a product, including a base price, a discount value, a tax-inclusive price, or a currency indication.

The term “display explanation information” refers to data used to present product candidate information to a user, such as product names, descriptions, usage notes, or recommendation reasons formatted for user display.

The term “individualized proposal information” refers to product candidate information adapted to a particular user, based on user preference information, user intention information, and generated result data, and transmitted to the user terminal for presentation.

The term “purchase operation information” refers to data received from the user terminal indicating a user's operation to purchase one or more products, including at least selected product identifiers, quantities, and optionally options such as size or color.

The term “order information” refers to data representing a transaction to purchase one or more products, including identifiers of the products, quantities, prices, payment information, shipping information, and optionally message information or packaging instructions.

The term “settlement processing unit” refers to a software or hardware module configured to perform payment-related processing for an order, including communication with a payment service, authorization, capture, and result recording.

The term “packaging instruction unit” refers to a software or hardware module configured to generate and output packaging-related instructions for ordered products, such as wrapping type, label content, or inclusion of printed messages.

The term “message information generation unit” refers to a software or hardware module configured to generate message information, including gift messages, by using the generative information processing model or by processing user-provided message input.

The term “delivery instruction unit” refers to a software or hardware module configured to generate and transmit shipping or delivery-related instructions to a delivery processing device, including shipping method, destination address, and tracking request information.

The term “distribution trend information” refers to data indicating trends or tendencies in product distribution, demand, or sales, such as popularity over time, seasonal patterns, or aggregate ranking information.

The term “popularity information” refers to data indicating a degree of popularity or preference for products or product categories, such as ranking values, review-based scores, or aggregated selection frequencies.

The term “product category information storage device” refers to a data storage apparatus or storage subsystem configured to store information relating to product categories, including category definitions, distribution trend information, and popularity information.

The term “delivery processing device” refers to an information processing apparatus or system that manages or executes shipping or delivery of products, including a logistics management system, a warehouse control system, or a carrier interface system.

The term “gift message” refers to textual message information intended to accompany a product as part of a gift, including greetings, expressions of gratitude, or celebratory statements, which can be printed or displayed along with the product.

In one embodiment, a server, a terminal, and a user cooperate to implement the invention. The server includes at least one processor, a main memory, a non-volatile storage device, a network interface, and access to one or more databases. The terminal includes a processor, a memory, a display device, an input device such as a touch screen or keyboard, and a network interface. The user operates the terminal to interact with the server.

The server executes an application program on general-purpose computing hardware, for example, a multi-core central processing unit and, in some embodiments, one or more graphics processing units. The server runs a server operating system such as a general-purpose operating system and a web application framework such as a general-purpose web framework. The server accesses a relational database management system such as a general-purpose relational database, and may also access a document-oriented database or a key-value store. The server uses a natural language processing library such as a general-purpose natural language library and a generative AI model framework such as a transformer-based large language model implementation.

The terminal executes a client application program implemented as a native mobile application, a web browser application, or a messaging application. The terminal presents a graphical user interface that allows the user to input free-form text describing desired products, preferences, and constraints. The terminal transmits this character information and user identification information to the server via a secure communication protocol over a communication network.

The server stores behavior history information in a behavior history information storage device implemented by the database management system. The server structures purchase history information and browsing history information in normalized tables with defined schemas. For example, a purchase history table stores records that include fields such as user_id, product_id, category_code, brand_code, unit_price, quantity, purchased_at, and optional attributes such as color_code and size_code. A browsing history table stores records that include fields such as user_id, product_id, category_code, viewed_at, dwell_time, and access_channel.

The server uses the processor to perform aggregation processing and tendency extraction processing on these tables. The server executes query operations that group records by attributes such as category_code, price_range, brand_code, color_code, and time period. The server calculates aggregate values such as counts, averages, medians, and frequency distributions. The server also computes derived metrics such as a preference score for each category or attribute, for example by applying a weighted function that combines recency, frequency, and monetary value. The server generates user preference information as a structured data object that may include, for example, a ranked list of preferred categories, typical price ranges, frequently chosen colors, and repeated brands.

The server applies specific algorithms to improve computational efficiency. For example, the server maintains pre-aggregated summary tables that are updated incrementally when new purchase history or browsing history records are inserted. The server uses index structures on user_id and time fields to speed up retrieval operations. By maintaining these data structures, the server reduces the amount of raw data that must be scanned and improves processing speed and scalability when generating user preference information.

The server uses a natural language processing unit to interpret the character information provided by the user. The server performs tokenization, part-of-speech tagging, dependency parsing, and named entity recognition using the NLP library. The server defines a domain-specific ontology that maps product-related terms and phrases to canonical product type information and constraint condition information. For example, the server maps phrases such as “summer clothes” or “lightweight jacket” to a category_code for seasonal apparel, and maps phrases such as “under 50 dollars” or “around 80 dollars” to normalized budget ranges. The server applies rule-based and statistical intent classification methods to derive user intention information such as “search for personal use,” “search for gift,” or “search for replacement item.”

The server leverages specific feature representations to improve intent classification accuracy. For example, the server uses word embeddings or contextual embeddings obtained from a pre-trained transformer model, and feeds these embeddings into a classifier implemented as a shallow neural network or a gradient boosting machine. The server combines these learned features with symbolic features derived from the domain ontology, such as category tags and constraint tags. By combining statistical and symbolic features, the server achieves higher robustness to noisy or ambiguous user input compared with simple keyword matching.

The server generates prompt sentence data to be provided to a generative AI model. The server converts the structured user preference information and the user intention information into natural language explanation information. The server also encodes constraint condition information such as budgets, recipient characteristics, occasions, and desired output length as explicit condition information. In addition, the server specifies output format information that instructs the generative AI model to output results according to a defined structure, such as a numbered list or a set of labeled fields.

The server constructs a prompt sentence by concatenating explanation information, condition information, and output format information using a deterministic template. For example, the server may construct a prompt sentence as follows: “The user is looking for casual summer clothes under 50 dollars.

The user's past purchase history shows frequent purchases of simple T-shirts and shorts in blue and white, with an average price of about 35 dollars.

Considering this preference information and current fashion trends, propose 7 concrete product recommendations.

For each product, provide:
(1) product type,
(2) short description,
(3) approximate price,
(4) brief reason why this product matches the user's preferences.”
In another example for a gift scenario, the server may construct a prompt sentence as follows: “The user is looking for a Mother's Day gift for a 60-year-old woman who enjoys gardening.

The budget is around 80 dollars.

Past gifts for the same recipient included books and small home decor items.

Considering this information and current gift trends, propose 5 concrete gift products suitable for Mother's Day.

For each product, provide:
(1) product category,
(2) brief description,
(3) a warm, short greeting message to print on a gift card.”

The server thus converts internal structured data into a controlled natural language prompt sentence. This controlled prompt design is not merely an automation of human drafting; it imposes a fixed schema on the generative AI model's input, which leads to more stable and machine-parsable output, reducing the need for manual correction and decreasing output variance.

In some embodiments, the server additionally incorporates distribution trend information and popularity information stored in a product category information storage device. The server periodically computes distribution trend information by analyzing aggregated sales data across multiple users and time periods. The server calculates popularity scores for each category and product based on metrics such as overall sales count, recent growth rates, and average review ratings. The server injects these scores into the prompt sentence as condition information, for example:

“Current trend data indicates high popularity of linen materials and neutral colors in summer apparel.

Please take into account these trends when selecting products.”

By explicitly encoding trend-related information in the prompt sentence, the server enables the generative AI model to bias its generation toward items that are not only aligned with an individual's preferences but also with broader market dynamics.

The server uses a generative AI model implemented as a transformer-based neural network. The generative AI model contains multiple layers of self-attention, multi-head attention mechanisms, and feed-forward networks. The server stores model parameters, such as weight matrices and bias vectors, that have been trained on large-scale text corpora. During training, the generative AI model minimizes a loss function, such as cross-entropy loss, between predicted token sequences and target token sequences, updating weights using gradient-based optimization algorithms such as stochastic gradient descent or Adam. The training process may include data augmentation methods such as random masking of tokens, shuffling of input segments, and curriculum learning strategies to expose the model to varying difficulty levels.

The server deploys the trained generative AI model for inference. The server tokenizes the prompt sentence into subword tokens using a predefined tokenizer. The server then feeds the token sequence into the generative AI model, which computes contextual representations via matrix multiplications, non-linear activations, and attention operations across the token positions. The server obtains generated result data as a sequence of tokens according to a decoding algorithm such as greedy decoding, beam search, or nucleus sampling, with parameters such as temperature and top-k or top-p values controlling diversity.

The server constrains the generative AI model's output by including explicit output format instructions in the prompt sentence. For example, the server instructs the model to output a numbered list where each item begins with a product type and contains a short explanation. This constraint facilitates deterministic parsing of the response. The server parses the output using pattern-based extractors and, in some embodiments, secondary lightweight models that classify segments of the generated text into fields such as product_type, description, approximate_price, and reason.

The server then aligns the generated product proposal information with concrete products stored in the product information storage device. The server uses similarity matching between generated product attributes and stored product attribute information, which may include vector-based similarity using embeddings of product descriptions, or rule-based matching on category_code, color_code, and price_range. The server filters out products that are out of stock by consulting inventory information and removes products that fall outside of region-specific availability constraints.

The server generates product candidate information that includes, for each selected product, a product identifier, a product name, a current price, an image reference, and a short explanation derived from or aligned with the reason text produced by the generative AI model. The server may normalize and compress this information into a compact data structure to reduce communication load when transmitting to the terminal. By generating tailored data structures, the server reduces the amount of data sent over the communication network, which improves response time and reduces network congestion.

The terminal receives the individualized proposal information and renders it on the display device. The terminal may present the information in various layouts, such as a list view, a grid view, or a carousel, optimized for the display size and interaction mode. The user selects one or more products and operates the terminal to initiate a purchase. The terminal transmits purchase operation information, such as selected product identifiers, quantities, and configuration options, to the server.

The server uses the processor to generate order information from the purchase operation information. The server checks inventory levels by querying the product information storage device, and it calculates a total price by applying tax rules and shipping fees according to predefined algorithms. The server then invokes a settlement processing unit that communicates with an external payment service through an application programming interface. The server handles payment tokens, authorization responses, and error codes, and stores payment status in the order information.

In gift scenarios, the server additionally generates prompt sentence data for a gift message by combining order information, user input regarding the occasion, and optional user instructions about tone or length. For example, the server may construct a prompt sentence such as: “The user is purchasing a Mother's Day gift: a gardening tool set for a 60-year-old woman.

Please generate a short, warm greeting message (within 50 words) suitable for a gift card.”

The server inputs this prompt sentence to the same or a different generative AI model, which is configured for short text generation. The server receives the generated message, validates its length and content using heuristic filters and, if necessary, simple toxicity or keyword filters, and associates the message information with the order information. The terminal displays the generated message for user confirmation, and the user may accept or modify it.

The server controls a packaging instruction unit to create packaging instruction information that includes the selected packaging type and the associated gift message. The server sends this information, along with the delivery address and shipping options, to a delivery processing device such as a logistics management system. The server thus bridges high-level recommendation and messaging logic with low-level device control and real-world operations such as label printing, package routing, and tracking number generation.

This architecture produces technical effects beyond mere automation of human operations. The server improves processing speed and scalability by using pre-aggregated summaries of behavior history, indexed database schemas, and efficient feature extraction for user preference modeling. The server increases recommendation precision by combining structured user preference information, explicit constraint condition information, and distribution trend information into controlled prompt sentences that systematically guide the generative AI model. The server reduces parsing errors and post-processing overhead by encoding explicit output format information in the prompt sentence design, resulting in more machine-readable and consistent generative outputs. The server reduces communication load by transmitting compact structured representations of product candidate information instead of full catalog data, which leads to lower network traffic and faster user-perceived response times.

The server also improves computational efficiency inside the generative AI pipeline. By pre-processing user input and behavior data into high-level features and constraints, the server reduces the need for the generative AI model to infer such information implicitly, thereby focusing the model's capacity on fine-grained text generation. This division of labor reduces model inference time and can enable the use of smaller or more specialized models for specific subtasks, such as message creation. Moreover, the server's rule-based prompt construction and format enforcement constitute non-conventional control logic that orchestrates the generative AI model in a manner tailored to the specific data structures and constraints of the product recommendation problem, rather than merely invoking a general-purpose model.

In alternative embodiments, the server may use different model architectures, such as encoder-decoder models, mixtures of experts, or models with adapters fine-tuned on domain-specific corpora. The server may adjust hyperparameters such as the number of layers, attention heads, or hidden dimensions, and may employ different learning rate schedules or regularization techniques during training. The server may also employ additional modules, such as re-ranking models that operate on the output candidates of the generative AI model, or calibration models that adjust confidence levels and control the diversity of outputs.

The terminal may likewise be implemented in different forms, such as a desktop client, a browser-based interface, or a voice-enabled device that converts spoken input into character information using a speech recognition module. The system may operate in environments with intermittent connectivity by caching behavior history summaries and product recommendations on the terminal and synchronizing with the server when connectivity is restored.

Through these embodiments, the server, the terminal, and the user cooperate in a technically specific manner that implements the claimed system. The system integrates behavior history analysis, natural language understanding, controlled prompt sentence generation for a generative AI model, structured product candidate retrieval, and transaction and delivery control, thereby improving the functioning of the computer system itself in terms of processing speed, precision, robustness, and communication efficiency, rather than merely automating a conventional human workflow.

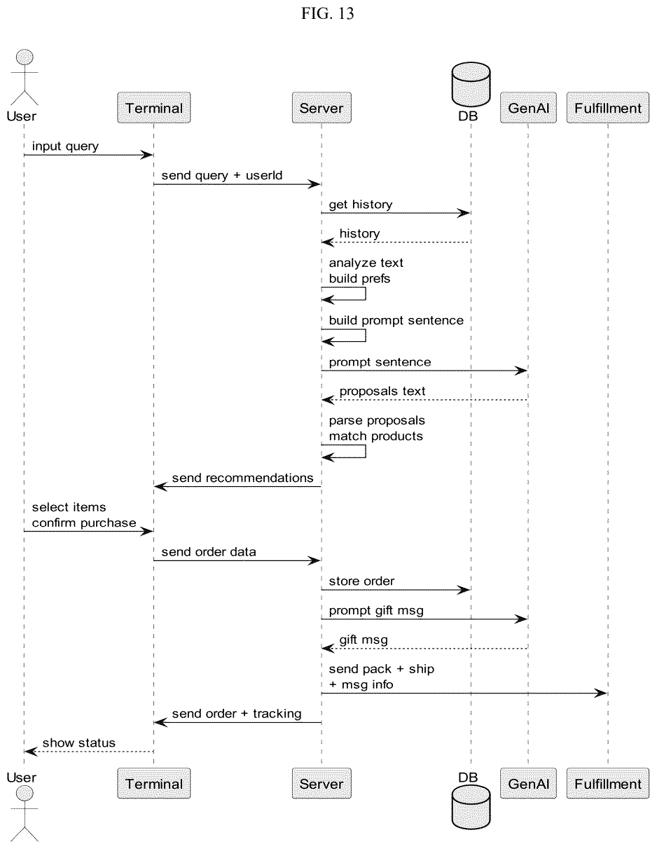

The following describes the processing flow using FIG. 13.

### Step 1

The user operates the terminal to launch an application and input character information. The terminal displays an input field and receives text such as “I want casual summer clothes under 50 dollars” together with implicit or explicit user identification information. The terminal sets as input the character information and the user identification information, and as output generates a structured request object that includes these elements. The terminal performs data formatting operations, such as encoding the character information in a text field and the user identification information in a separate identifier field, and then transmits the structured request to the server via a communication network.

### Step 2

The server receives the request object sent from the terminal. The server sets as input the structured request containing the character information and the user identification information, and as output generates validated request data stored in working memory. The server performs request validation operations, including checking authentication tokens, verifying that mandatory fields are present, normalizing character encoding, and logging metadata such as timestamps and network source. The server thereby produces a clean, normalized input suitable for subsequent processing steps.

### Step 3

The server retrieves behavior history information corresponding to the user. The server sets as input the user identification information from the validated request data, and as output generates behavior history records including purchase history information and browsing history information. The server performs database access operations by issuing queries to a behavior history information storage device, filtering records by the user identification information and an optional time range. The server then loads the resulting records into memory as structured data, distinguishing purchase history records, browsing history records, and their associated attributes.

### Step 4

The server generates user preference information from the retrieved behavior history. The server sets as input the purchase history records and browsing history records, and as output generates user preference information expressed as structured fields such as preferred categories, price ranges, colors, and brands. The server performs aggregation processing by grouping records by attributes (for example, category, price band, color) and computing statistics such as counts, averages, and recency-weighted scores. The server then performs tendency extraction processing by applying algorithms that weight recent behavior more heavily than older behavior and calculate preference scores, thereby converting raw history records into compact preference indicators.

### Step 5

The server performs semantic analysis on the character information provided by the user. The server sets as input the character information from the validated request and as output generates product type information, constraint condition information, and user intention information. The server applies a natural language processing unit to perform tokenization, part-of-speech tagging, and named entity recognition, and then executes rule-based and learned classifiers to map detected phrases to internal representations. For example, the server converts “summer clothes” to a product type code, converts “under 50 dollars” to a numerical budget constraint, and classifies the overall intent as a product search or gift search. The server thus transforms unstructured text into structured semantic data.

### Step 6

The server optionally augments the semantic data with distribution trend information and popularity information. The server sets as input the product type information and internal category codes derived from the semantic analysis, and as output generates augmented condition information that includes trend-related attributes. The server queries a product category information storage device for recent sales trends, popularity rankings, and seasonal patterns associated with the relevant categories. The server then performs data combination operations that merge trend scores and popularity scores into the condition information, thereby preparing richer constraints for subsequent recommendation generation.

### Step 7

The server generates prompt sentence data for a generative AI model. The server sets as input the user preference information, the product type information, the constraint condition information, the user intention information, and, when available, the trend and popularity information, and as output generates a prompt sentence in natural language together with internal metadata representing the structure. The server executes a template-based construction algorithm that concatenates explanation information describing the user's history and preferences, condition information specifying constraints such as budget and recipient, and output format information describing the required structure of the model's response. For example, the server constructs a prompt sentence such as:

“The user is looking for casual summer clothes under 50 dollars. The user's past purchase history shows frequent purchases of simple T-shirts and shorts in blue and white, with an average price of about 35 dollars. Considering this preference information and current fashion trends, propose 7 concrete product recommendations. For each product, provide: (1) product type, (2) short description, (3) approximate price, (4) brief reason why this product matches the user's preferences.”

The server thereby converts structured internal data into a controlled natural language prompt suitable for the generative AI model.

### Step 8

The server inputs the generated prompt sentence to the generative AI model and obtains generated result data. The server sets as input the prompt sentence and model configuration parameters (such as maximum output length and decoding strategy), and as output generates model-produced text including product proposal information. The server tokenizes the prompt sentence into tokens compatible with the generative AI model, sends the token sequence to the model inference engine, and receives a sequence of output tokens. Internally, the generative AI model executes numerical operations such as matrix multiplications and attention calculations, but from the server's perspective the operation is a deterministic call that yields an output string. The server converts the output tokens back into text and encapsulates this text as generated result data.

### Step 9

The server parses and structures the generated result data. The server sets as input the text output from the generative AI model, and as output generates structured product proposal information, including fields such as product type, description, approximate price, and recommendation reason for each proposed item. The server applies parsing rules based on the output format instructions contained in the prompt sentence, for example splitting on numbered list markers, extracting lines that begin with product descriptors, and mapping portions of text to predefined fields. The server may also apply secondary natural language processing to detect product attributes within the generated text, thereby converting free-form responses into a machine-usable proposal list.

### Step 10

The server matches the structured product proposal information with actual products stored in the product information storage device. The server sets as input the structured product proposal information and the stored product attribute information, and as output generates product candidate information that references specific product identifiers. The server performs attribute matching operations, such as comparing proposed categories, colors, and price ranges to catalog entries, computing similarity scores, and selecting the best-matching items under predefined constraints. The server also queries inventory information to filter out products that are not available, and retrieves current price information and display explanation information for the remaining products. The server thus transforms abstract proposals into concrete candidates that can be purchased.

### Step 11

The server composes individualized proposal information for transmission to the terminal. The server sets as input the product candidate information and any additional explanation text produced by the generative AI model, and as output generates a response object formatted for the terminal. The server performs data selection and compression operations, choosing fields such as product identifier, product name, price, image reference, and a short reason for recommendation. The server may reorder candidates according to relevance scores or strategy rules to optimize user engagement. The server then serializes this structured data into a compact format and sends it over the communication network to the terminal.

### Step 12

The terminal receives and displays the individualized proposal information. The terminal sets as input the structured response from the server, and as output generates a user interface view presenting recommended products on the display device. The terminal parses the structured data, downloads product images if required, and populates visual components such as lists or grids. The terminal may format the recommendation reason text to highlight key phrases. The terminal thus converts machine-readable proposal data into a human-readable presentation and enables interaction elements such as buttons for selecting products or proceeding to checkout.

### Step 13

The user reviews the recommended products and performs purchase operations on the terminal. The user sets as input the presented product list and interacts with the terminal to select items, specify quantities, and choose options such as size or color. The terminal receives these operations and as output generates purchase operation information containing selected product identifiers, quantities, and configuration options. The terminal aggregates these selections into a structured order request and transmits this request to the server via the communication network.

### Step 14

The server generates order information and initiates settlement processing. The server sets as input the purchase operation information from the terminal and the product candidate information previously used for recommendation, and as output generates order information that includes product details, prices, tax amounts, shipping costs, and user destination information. The server performs calculations to sum product prices, apply tax rules, and determine shipping fees based on preconfigured algorithms. The server then invokes a settlement processing unit, which communicates with an external payment service, using the order information and payment credentials. The server receives authorization results and updates the order information to include payment status, thereby converting a tentative selection into a confirmed transaction.

### Step 15

The server generates a gift message when requested and associates it with the order. The server sets as input the order information, user-specified occasion data, and optional user instructions regarding tone and length, and as output generates message information containing a gift message. The server constructs a prompt sentence such as:

“The user is purchasing a Mother's Day gift: a gardening tool set for a 60-year-old woman. Please generate a short, warm greeting message (within 50 words) suitable for a gift card.”

The server sends this prompt sentence to the generative AI model, receives the generated text, and then applies validation rules to check length and filter inappropriate content. The server embeds the validated message into the order information as structured message information, linking it to specific items or to the entire order.

### Step 16

The server generates packaging and delivery instruction information and transmits it to a delivery processing device. The server sets as input the order information, including message information and user-selected packaging options, and as output generates packaging instruction information and delivery instruction information. The server performs data transformation operations that convert logical selections into concrete operational parameters, such as packaging type codes, label text layouts, and shipping method codes. The server sends these instructions to the delivery processing device, which controls physical equipment such as printers and sorting machines. By providing structured, machine-readable instructions tied to the order, the server ensures that the real-world packaging and shipment processes are consistent with the recommendations and messages generated earlier.

### Step 17

The terminal receives confirmation and status information from the server. The terminal sets as input the order confirmation data and tracking information sent by the server, and as output generates display content that informs the user of the order status, the included gift message, and shipment tracking identifiers. The terminal updates its user interface to reflect the completion of the transaction and may store summary data locally for later reference. The user can then monitor the progress of the shipment through the terminal, closing the loop between recommendation, selection, purchase, and delivery within a single integrated system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computerized recommendation systems in electronic commerce environments typically rely on fixed rules or shallow machine learning models that operate on limited user attributes and simple behavior logs. Such systems generally generate recommendations by applying static ranking algorithms to precomputed product lists. As a result, these systems exhibit several technical limitations in terms of how computing resources are used to process heterogeneous user inputs and how dynamically generated content is integrated into the transaction flow.

First, existing systems are not designed to efficiently transform rich, natural-language user inputs into machine-usable signals for downstream processing. In many cases, the system merely searches for keywords in a product catalog, without performing deeper analysis of user intent, user history, or user emotional state. This leads to repeated and redundant server-side processing, including multiple round-trip requests, ad-hoc query reformulations, and manual curation steps, which increase processing latency, consume excess memory and CPU cycles, and reduce throughput on the server.

Second, conventional architectures treat large-scale generative models, when used at all, as isolated text generators that are manually prompted by application logic. The server lacks an integrated mechanism to systematically construct, log, and reuse prompt sentences based on structured user data, analysis results, and transaction states. As a result, the generative AI model is often underutilized or inconsistently utilized, and the server must perform additional compensation logic to post-process or correct generated outputs, further degrading system efficiency and reliability.

Third, existing systems generally do not maintain a closed feedback loop between user selections, generated content (such as recommendations, packaging options, and message drafts), and future prompt generation. Without recording the correlation between generated prompts, AI outputs, and subsequent user actions, the server cannot optimize its future prompt construction or data retrieval paths. This results in repetitive and suboptimal computations for similar users or recurring scenarios, increasing storage access frequency and processing overhead.

Fourth, typical systems handle support processes such as packaging selection, decorative options, and message drafting as separate, often manual, workflows. The absence of unified, AI-assisted orchestration for these processes leads to multiple disjoint calls, redundant database queries, and fragmented state management. This separation increases the complexity of server-side control logic, imposes additional loads on communication interfaces, and reduces the overall responsiveness and scalability of the system.

Therefore, there is a need for an improved computer-implemented system and server-side processing technique that: (i) systematically analyzes user inputs, history, and emotional state; (ii) automatically generates structured prompt sentences for a generative AI model; (iii) integrates the generative AI model's outputs into core transaction flows, including product proposal, packaging, and messaging; and (iv) records interactions as history for use in optimizing subsequent prompts and proposals. Such a system should improve the efficiency, determinism, and scalability of the server's computation, while reducing redundant processing and latency in serving individualized proposals to user devices.

The specific processing by the specific processing unit 290 of the data processing device 12 in Application Example 2 is realized by the following means.

The present invention provides a server comprising a processor configured to acquire user information via a communication unit that enables bidirectional information exchange with a user terminal, analyze the acquired user information by using a data analysis unit to determine at least one of a user request, a user attribute, a user history, and a user emotional state, generate a structured prompt sentence for input to a generative AI model on the basis of the user information and an analysis result obtained by the data analysis unit, execute a generation process by using the generative AI model on the basis of the prompt sentence to generate item candidates and description information associated with the item candidates, acquire item data from an item data storage unit and generate item proposal information by associating the generated item candidates and the description information with the item data, present, on the basis of the item proposal information, at least one of an item, a packaging mode, a decoration, and a message draft to the user and support at least one of a purchase procedure and a delivery arrangement in accordance with a selection made by the user, and store, as history information, at least a selection result of the user, the prompt sentence input to the generative AI model, and a response content from the generative AI model, and reflect the stored history information in generation of a subsequent prompt sentence and generation of subsequent item proposal information. This enables the server to transform heterogeneous user inputs into optimized prompt sentences and corresponding generative model outputs in a closed-loop fashion, thereby reducing redundant computations and database accesses, lowering end-to-end response latency, and improving the determinism and scalability of server-side processing for individualized product, packaging, and message proposals.

The term “processor” refers to a hardware computation unit, such as a central processing unit or a programmable logic device, configured to execute instructions stored in a memory to perform the functions described in the present disclosure.

The term “communication unit” refers to a hardware and software combination configured to enable bidirectional transmission and reception of data between the server and an external device, such as a user terminal, over a communication network.

The term “user information” refers to data received from a user or a user terminal, including at least one of natural-language text, structured input, user profile data, behavioral logs, and contextual parameters related to a transaction.

The term “data analysis unit” refers to a software component or a set of software components executed by the processor and configured to process and interpret user information by using at least one of parsing, classification, statistical analysis, and machine learning.

The term “user request” refers to at least one intention or objective of a user inferred from user information, such as a desire to search for an item, purchase an item, request a recommendation, or obtain auxiliary services.

The term “user attribute” refers to descriptive data associated with a user, including at least one of demographic information, preference information, account information, and device-related information.

The term “user history” refers to previously recorded data related to the user, including at least one of purchase records, browsing records, selection records for packaging or messages, and interaction logs with the system.

The term “user emotional state” refers to an inferred affective condition of the user, such as stress, fatigue, joy, or satisfaction, determined from user information by an emotion analysis process.

The term “emotion analysis unit” refers to a software component or a set of software components executed by the processor and configured to determine the user emotional state by applying emotion detection or sentiment analysis to at least one of text data and history data.

The term “prompt sentence” refers to a structured natural-language or semi-structured text string generated by the processor for input to a generative AI model, the text string specifying conditions, context, and instructions for a generation process to be executed by the generative AI model.

The term “generative AI model” refers to a machine learning model configured to generate text or other data in response to an input prompt sentence, the model including at least a neural network that has been trained on sample data to produce context-appropriate outputs.

The term “generation process” refers to processing performed by the generative AI model in response to a prompt sentence, including computation of internal model states and output of generated content such as item candidates, explanations, or message drafts.

The term “item candidate” refers to a data representation of a proposed item or service selected or generated for a user by the generative AI model or by the processor, prior to final selection by the user.

The term “description information” refers to explanatory text or metadata associated with an item candidate, including at least one of reasons for recommendation, feature summaries, and usage suggestions.

The term “item data storage unit” refers to a storage device or storage subsystem that stores item data, including at least one of item identifiers, names, attributes, prices, images, and inventory states.

The term “item data” refers to structured information describing an item or service available for proposal or purchase, including at least one of identification data, descriptive attributes, pricing information, and availability information.

The term “item proposal information” refers to structured information generated by the processor by associating item candidates and description information with corresponding item data, the structured information being suitable for presentation to a user.

The term “packaging mode” refers to information specifying a type of physical or virtual wrapping or presentation style associated with an item, including at least one of wrapping material, color, pattern, and form factor.

The term “decoration” refers to an additional visual or physical enhancement applied to packaging or an item, including at least one of decorative bands, printed designs, labels, and ornamental components.

The term “message draft” refers to a candidate text for a message to be associated with an item or a transaction, the candidate text being generated by the generative AI model or prepared by the processor, and being subject to selection or editing by the user.

The term “purchase procedure” refers to a sequence of operations executed by the processor to complete a transaction for an item candidate, including at least one of cart creation, payment processing, stock verification, and order confirmation.

The term “delivery arrangement” refers to a sequence of operations executed by the processor to cause physical or digital delivery of an item to a destination, including at least one of shipping request creation, label generation, scheduling, and tracking information registration.

The term “history information” refers to data stored by the processor regarding past interactions between a user and the system, including at least one of user selections, prompt sentences provided to a generative AI model, and responses obtained from the generative AI model.

The term “user selection result” refers to data that identifies at least one choice made by the user from among items, packaging modes, decorations, or message drafts that have been presented by the system.

The term “response content” refers to the data output by the generative AI model in response to a prompt sentence, including at least one of item candidates, explanations, and message drafts.

The term “subsequent prompt sentence” refers to a prompt sentence that is generated after storage of history information and that is modified or optimized in accordance with at least part of the stored history information.

The term “network” refers to a communication infrastructure that enables data exchange between the server and at least one external device, including at least one of a local area network, a wide area network, and a public data communication network.

The term “user terminal” refers to an information processing device operated by a user, including at least one of a smartphone, a tablet device, a personal computer, and a dedicated client device, capable of executing a communication application.

The term “display device” refers to a visual output unit associated with a user terminal or server-side equipment, configured to present item proposal information and related content to a user in human-readable form.

In one embodiment, a server, a terminal, and a user cooperate to implement the invention. The server includes at least one processor, a memory device, a network interface, and a nonvolatile storage device. The terminal includes at least one processor, a memory device, a display device, an input interface, and a network interface. The user operates the terminal to interact with the server.

The server executes an operating system, an application server, and multiple software modules implementing a communication unit, a data analysis unit, an emotion analysis unit, a prompt generation unit, a generative AI interface unit, an item data management unit, a proposal generation unit, and a history management unit. The server uses a relational database management system such as a generic SQL database to store user information, item information, and history information. The server uses a machine learning framework such as a tensor computation framework or a generic deep learning framework to execute a generative AI model and an analysis model. The server optionally uses a natural language processing library such as a transformer-based library and an HTTP client module to communicate with external AI or emotion analysis services.

The terminal executes a communication application that connects to the server over a network such as the Internet. The terminal renders a user interface using a graphical rendering library or a web browser. The terminal displays item proposal information, packaging modes, decorations, and message drafts, and the terminal transmits user selections and free-text inputs to the server.

The server maintains structured data in the memory and storage device. The server stores user information in a user table having fields such as user identifier, profile attributes, preference vectors, and accumulated statistics. The server stores item information in an item table having fields such as item identifier, category code, attribute vector, price, stock state, and link to image data. The server stores history information in a history table having fields such as user identifier, timestamp, prompt sentence, model output content, selected item identifier, selected packaging mode, selected decoration, and selected message text.

The server uses the data analysis unit to transform heterogeneous user inputs into machine-interpretable features. The server parses natural-language text with a tokenizer to convert a character sequence into token identifiers and position indices. The server feeds the token sequence into a neural network model such as a transformer-based encoder with multiple self-attention layers and feed-forward layers. The server computes contextual embeddings for each token and aggregates them using a classification head to produce an intent label, an item-related entity list, and additional attributes such as event type or recipient type. The server thereby converts unstructured text into compact feature vectors, reducing the dimensionality and enabling efficient downstream processing.

The server uses the emotion analysis unit to infer a user emotional state. In one embodiment, the server sends user text to an external emotion classification service providing sentiment and tone scores. In another embodiment, the server executes a local neural network that takes token embeddings as input and outputs a probability distribution over emotional categories such as stress, fatigue, joy, and calmness. The server calculates a cross-entropy loss during training of this network and adjusts the weights by gradient descent. The server stores the inferred emotional state as an additional feature in the user's profile and in the current history record.

The server uses the prompt generation unit to construct a prompt sentence for a generative AI model. The server concatenates multiple pieces of structured information into a natural-language instruction. The server includes at least the user request, a summary of the user history, the inferred emotional state, and a description of candidate items. The server also specifies a desired output format and constraints in the prompt sentence. The server stores the prompt sentence in a prompt field within the history table before sending it to the generative AI model.

In one example, the server generates a prompt sentence of the following form:

“User input: summer clothes.

User intent: search for summer clothing suitable for casual daily use.

User history: frequent purchases of T-shirts and light jackets, preferred colors blue and white, typical price range 3,000-8,000 yen.

User emotional state: slightly tired and seeking comfort.

Candidate items: several summer clothing items with different fabrics and colors.

Please recommend up to five optimal summer clothing items for this user and explain in Japanese why each item matches the user's preferences and emotional state. Return brief explanations suitable for display on a mobile device.”

In another example, the server generates a prompt sentence related to a gift:

“The user wants to buy a Mother's Day present.

Recipient: mother.

User history: previous purchases of cosmetics and accessories as gifts.

Please recommend several suitable gift items for Mother's Day, and also propose appropriate packaging styles and short Japanese message drafts expressing gratitude. Keep each message within about 80 Japanese characters.”

The server uses the generative AI interface unit to transmit the prompt sentence to a generative AI model. In one embodiment, the server executes a transformer-based language model locally. The server loads pre-trained model parameters into a deep learning framework and places them into GPU memory. The server supplies the prompt tokens to a decoder or encoder-decoder architecture, computes attention weights over past tokens, and generates output tokens sequentially until an end-of-sequence condition is satisfied. The server uses a sampling strategy such as top-k sampling or nucleus sampling with temperature control to balance diversity and determinism.

In another embodiment, the server sends the prompt sentence to an external generative AI service via an HTTPS request. The server includes the prompt sentence in the request payload and receives generated text as a response. In both embodiments, the server parses the generated text and extracts item candidates, explanation phrases, and message text according to the output format specified in the prompt.

The server uses the item data management unit to map logical item candidates to concrete entries in the item database. When the generative AI model outputs references to item identifiers or attribute criteria, the server executes structured queries against the relational database to retrieve matching item data. The server constructs compact item records containing only the fields needed for display, which reduces memory transfer and network bandwidth when sending proposals to the terminal.

The server uses the proposal generation unit to combine item records with explanation text and to generate item proposal information. The server includes, for each item, a link to an image file, a name, a price, and a generated explanation adapted to the user's context. The server also computes a ranking score for each item using a numerical function that integrates model confidence scores, similarity between item attribute vectors and user preference vectors, and inventory status. The server orders the proposal list by this ranking score before transmission.

The server also uses the prompt generation unit and the generative AI interface unit to generate auxiliary content such as packaging suggestions and message drafts. For packaging, the server may construct a prompt sentence such as:

“The user has selected a birthday gift for a close friend.

Item: aroma candle.

Please propose three packaging styles suitable for a casual birthday gift, and describe each style briefly in Japanese, including color and design.”

For message drafts, the server may generate a prompt sentence such as:

“The user purchased an aroma candle as a self-care item.

The user is tired after work and wants an encouraging short message printed on the package.

Please generate one short Japanese message with a gentle and supportive tone, within 60 characters.”

The server receives multiple candidate packaging descriptions and message drafts from the generative AI model and logs them in the history table. The server then transmits the candidate options to the terminal as part of the proposal information.

The terminal displays item proposal information, packaging options, and message drafts on the display device. The terminal may present each item in a card layout including an image thumbnail, a title, a price, and a generated explanation. The terminal presents packaging and decoration options as selectable tiles with small preview images and labels. The terminal displays message drafts in editable text fields, enabling the user to modify the generated text.

The user selects at least one item, a packaging mode, a decoration, and a message draft using the input interface of the terminal. The terminal transmits the selection data to the server. The server updates the order record with the selection data and uses this information as part of the history information. The server later uses the stored prompt sentences, AI outputs, and user selection results to refine future prompt generation. For example, the server may compute a feedback signal indicating whether a generated item candidate was selected or rejected and may adjust prompt structures, weighting of history features, or ranking heuristics accordingly.

The server thereby improves computational efficiency in several ways. The server uses feature extraction and intent recognition to reduce the number of database queries by selecting only relevant item categories and price ranges. The server uses a structured prompt sentence that explicitly encodes user state and output format, which reduces the need for heavy post-processing of AI outputs and avoids repeated back-and-forth queries with the AI model. The server stores and reuses history information to reduce redundant analysis of similar scenarios; for users with similar profiles and contexts, the server can adjust prompts incrementally instead of constructing them from scratch.

From a technical perspective, the server implements specific data structures and algorithms to optimize memory usage and processing latency. The server maintains normalized embedding vectors for users and items and uses vector similarity computations to prefilter candidates before invoking the generative AI model. This prefiltering reduces the token length of candidate descriptions inserted into the prompt sentence and thus reduces computational complexity of the transformer layers. The server controls the temperature and sampling parameters of the generative AI model based on context (for example, lower temperature for transactional outputs, higher temperature for creative messages) to obtain stable and concise outputs that require minimal correction.

The server trains the generative AI model and auxiliary models using supervised learning and fine-tuning. During training, the server minimizes an error function such as cross-entropy loss between generated tokens and reference tokens in training pairs derived from historical recommendation logs and editorial data. The server updates model weights by stochastic gradient descent or an advanced optimizer. The server optionally applies data augmentation techniques such as paraphrasing of user queries or synthetic variations of messages to increase robustness and reduce overfitting. The server may periodically retrain or fine-tune models using newly accumulated history information, thereby improving accuracy and reducing the need for manual rule updates.

Because the server uses learned embeddings, transformer architectures, and closed-loop history-based prompt optimization, the processing is different from simple automation of human decision rules. A human operator would typically apply ad hoc reasoning to each user request and would not consistently encode complex combinations of user history, emotion, and item attributes into a single instruction. In contrast, the server constructs prompt sentences and feature sets according to predefined, non-conventional algorithms that operate on high-dimensional embeddings and structured logs. This algorithmic structure enables the server to apply consistent, machine-optimized rules for generating and ranking item proposals, which would not be feasible with a conventional rule-based system or a manual process.

In one variation, the server executes the generative AI model on dedicated accelerator hardware, such as a graphics accelerator or a specialized AI computation unit. The server uses batch processing of prompts to serve multiple user requests concurrently, which improves throughput. The server applies caching of embeddings and partial model outputs for frequently occurring segments of prompt sentences. This caching reduces recomputation of lower-layer activations in the transformer network, thereby improving response time and reducing energy consumption.

In another variation, the server integrates a local emotion analysis unit that operates directly on acoustic or multimodal input streams, such as voice messages or combined text and image data. The server converts these modalities into feature vectors and feeds them into an extended neural network architecture that predicts emotional state more accurately. The server then uses the refined emotional state in prompt sentences to generate more context-appropriate messages and proposals, which reduces the rejection rate of suggestions and thereby reduces repeated interaction cycles.

In a further variation, the server divides the prompt generation unit into separate submodules for intent description, history summarization, and constraint specification. The server maintains template libraries for each submodule and composes final prompt sentences by selecting and filling templates based on deterministic rules and learned parameters. This modular architecture makes the prompt generation process itself programmable and optimizable, enabling systematic experimentation with different template combinations to achieve lower variance in model outputs and higher user acceptance rates.

Overall, the server performs specific computational operations on defined data structures to transform raw user inputs and stored data into optimized instructions for a generative AI model and into finalized item proposal information. The server reduces communication load between the terminal and the server by sending compact, pre-aggregated proposal data rather than raw product catalogs. The server reduces the number of interactions with external AI services by constructing information-rich prompt sentences that yield useful outputs in a single call. The system thereby achieves technical effects such as improved processing speed, improved recommendation precision, reduced redundant calculations, and reduced network bandwidth consumption, which collectively represent an improvement in computer technology rather than a mere automation of human business processes.

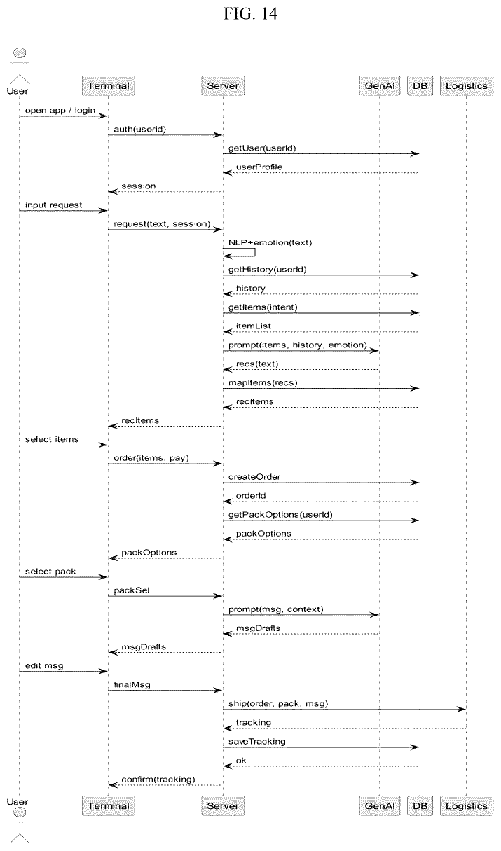

The following describes the processing flow using FIG. 14.

### Step 1

The user launches an application on the terminal and initiates interaction with the server.

The terminal establishes a network connection to the server and sends an authentication token or user identifier as input.

The server receives the identifier as input, executes a database lookup on a user table, and outputs a user profile record containing at least a user ID, language setting, and preference summary.

The server stores the user profile data in a session data structure in memory and outputs a session identifier to the terminal.

### Step 2

The user inputs a natural-language request or keyword through the user interface on the terminal.

The terminal receives the text as input from the user (for example,“summer clothes”, “I want to buy a Mother's Day gift”, or “I'm very tired today”) and outputs a structured request message including the text, the user ID, and the session identifier.

The terminal sends this structured request to the server via a communication application using a network protocol.

### Step 3

The server receives the structured request message as input and extracts the text component and the user ID.

The server uses a tokenizer module to convert the text into a sequence of token identifiers and position indices, and outputs tokenized text data.

The server feeds the tokenized text data into a transformer-based encoder model as input, performs matrix multiplications, self-attention calculations, and non-linear activations, and outputs contextual embeddings and classification logits.

The server applies a classification layer to the logits and outputs an intent label, an entity list, and auxiliary attributes such as event type or recipient type.

### Step 4

The server uses the tokenized text or raw text as input to an emotion analysis unit.

The server either sends the text to an external emotion analysis service or processes the embeddings with a local classifier network and outputs an emotional state label (for example, stress, fatigue, joy) with confidence scores.

The server stores the emotional state as part of the current request context and outputs a combined analysis result containing intent, entities, attributes, and emotional state.

### Step 5

The server receives the user ID as input and queries a database storing user history.

The server executes SQL statements to retrieve purchase records, browsing records, past packaging choices, and past message selections, and outputs a set of history rows.

The server loads these history rows into an in-memory data structure, aggregates counts and averages (for example, average price, most frequent categories, preferred colors), and outputs a compact history summary vector and a textual summary string.

### Step 6

The server takes the intent, entities, and history summary as input to an item retrieval component.

The server constructs parameterized SQL queries using item category codes, price constraints, and attribute filters derived from the analysis result and executes these queries on an item data table.

The server outputs a candidate item list containing item identifiers, attribute vectors, prices, and availability flags.

### Step 7

The server receives the combined analysis result, the history summary string, the emotional state, and the candidate item list as input to a prompt generation unit.

The server assembles these elements into a coherent natural-language instruction and generates a prompt sentence for a generative AI model as output.

The server concatenates text segments in a predetermined order (for example, user input, intent description, history summary, emotion description, candidate outline, and output constraints), applies template rules, and outputs the final prompt sentence.

The server stores the prompt sentence in a history table and forwards the prompt sentence to a generative AI interface module.

### Step 8

The server sends the prompt sentence as input to a generative AI model.

The server either encodes the prompt with a tokenizer and runs it through a local transformer-based language model, or transmits the prompt via an API call to an external generative AI service.

The generative AI model processes the prompt by computing attention over tokens and generating output tokens until a stopping condition is met, and outputs generated text containing item candidate selections, recommendation reasons, and optionally packaging and message suggestions.

The server receives this generated text and outputs a parsed representation, such as a list of structured item candidate descriptions with associated explanations.

### Step 9

The server takes the structured item candidate descriptions and the item database as input to a mapping unit.

The server matches generated item identifiers or attribute conditions to concrete item records by executing database lookups or similarity searches on item attribute vectors.

The server outputs a refined item proposal list in which each element contains a confirmed item identifier, name, price, image link, and the AI-generated explanation.

### Step 10

The server transmits the refined item proposal list as input to the terminal via the communication unit.

The terminal receives the list and transforms it into visual elements using a rendering engine, and outputs a graphical display of product cards including images, names, prices, and explanation text.

The user views the displayed items and inputs a selection decision by tapping or clicking on one or more items.

### Step 11

The terminal collects the selected item identifiers and quantities as input from the user.

The terminal constructs an order request message including the user ID, the selected items, and payment authorization data, and outputs this message to the server.

The server receives the order request, checks stock and price consistency by querying the item table, and outputs an order record with a provisional status.

### Step 12

The server sends the selected items and contextual data (for example, event type, recipient relation) as input to a packaging suggestion module.

The server retrieves any past packaging and decoration choices for the user from a packaging history table and computes preference scores for available packaging modes and decorations.

The server outputs a ranked list of packaging modes and decorations, each with a label and optional preview image reference, and transmits this list to the terminal.

The terminal displays the options and outputs the user's packaging and decoration selections back to the server.

### Step 13

The server collects the order record and the packaging and decoration selections as input to a second prompt generation operation for message drafts.

The server generates a new prompt sentence that describes the item, the event, the recipient, the emotional tone, and the selected packaging, and specifies constraints such as message length and style.

The server outputs this second prompt sentence and sends it to the generative AI model.

The generative AI model receives the prompt sentence as input, executes a text generation process, and outputs one or more candidate message drafts formatted as natural-language text.

### Step 14

The server parses the generated message drafts as input and stores them in association with the current order record in a message candidate table.

The server transmits the message drafts to the terminal.

The terminal receives the message drafts and outputs them on the display as selectable and editable text fields.

The user selects one message and optionally edits the text, and the terminal outputs the final message text to the server.

### Step 15

The server receives the final message text as input and updates the order record to include the confirmed message, packaging mode, and decoration.

The server then sends order details, including destination address, item list, and packaging information, as input to a delivery arrangement module that interfaces with a logistics system.

The server transmits shipment creation requests to an external logistics API and receives tracking numbers and label references as output.

The server stores the tracking information in the order record and outputs a shipment confirmation notification to the terminal.

### Step 16

The server aggregates, as input, the prompt sentences used, the generative AI model outputs, the user's final selections, and the outcome of the transaction.

The server writes this aggregated data as history information into the history table, updating user preference vectors and interaction statistics.

The server computes feedback metrics such as selection rate per generated candidate and error patterns in generated text, and outputs updated control parameters for subsequent prompt generation and ranking functions.

The server thereby refines future processing by adjusting feature weights, template choices, or sampling parameters, resulting in improved accuracy and reduced computation for similar future requests.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

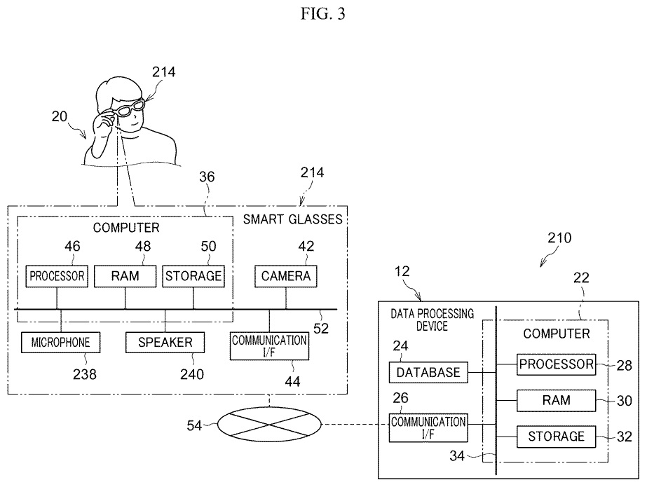

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

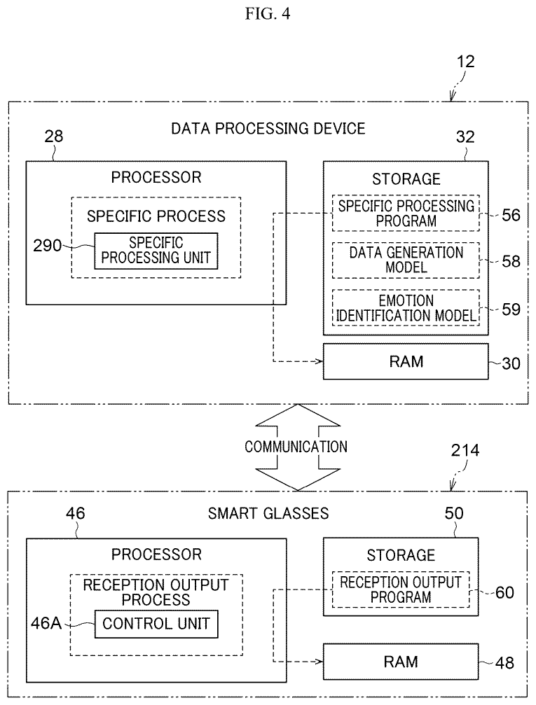

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

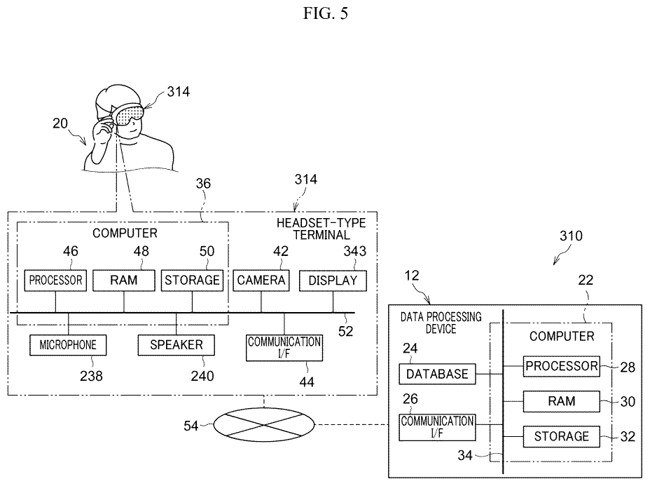

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

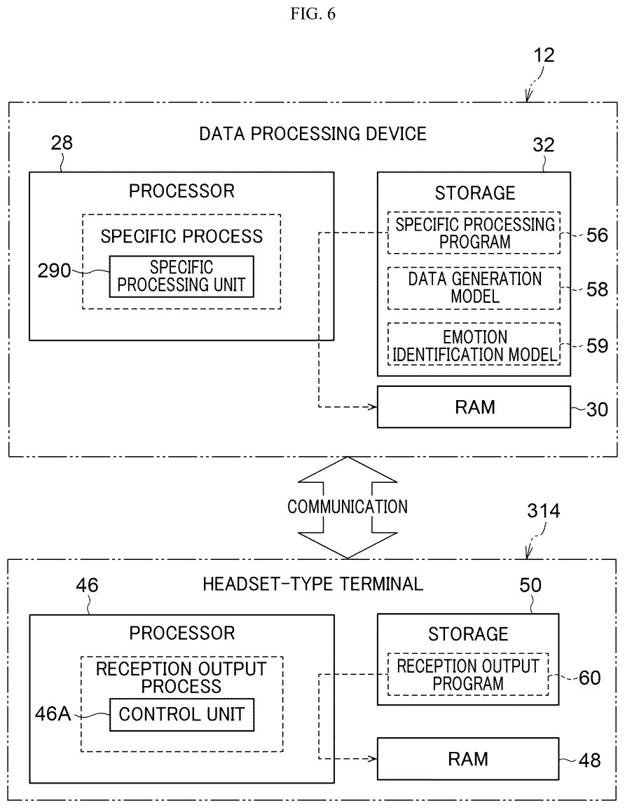

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

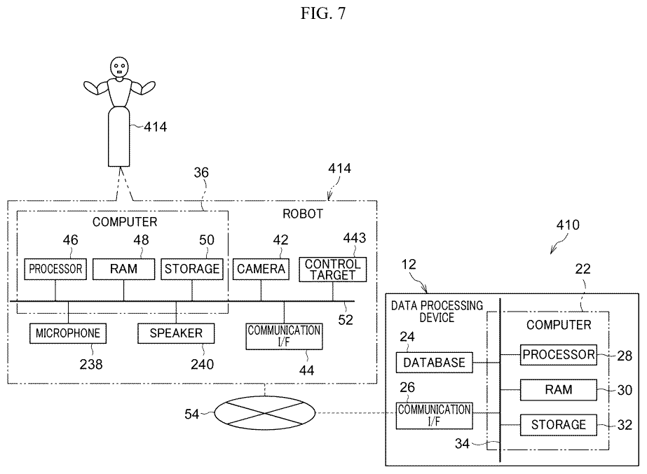

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

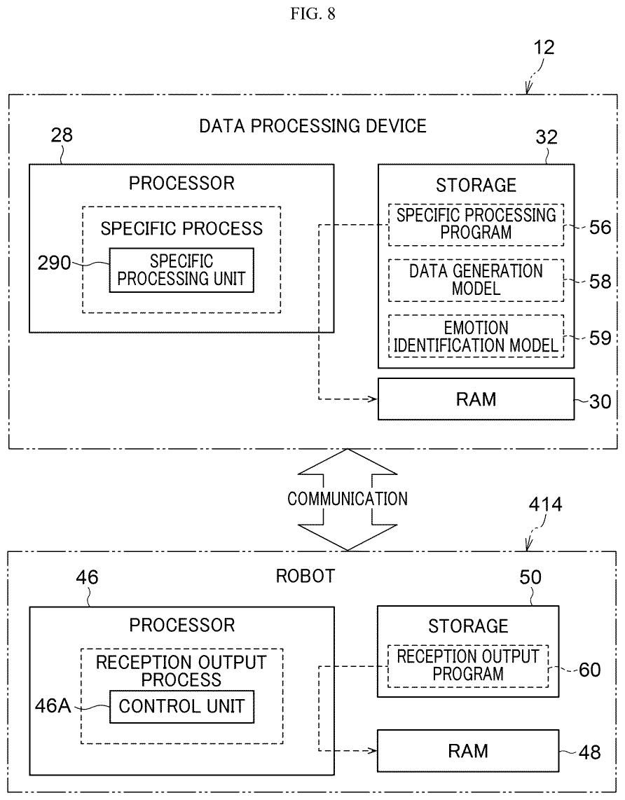

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

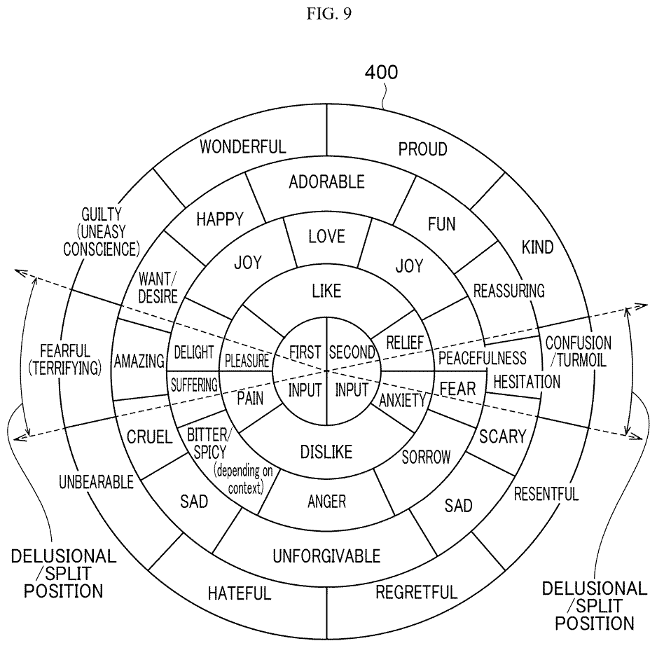

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

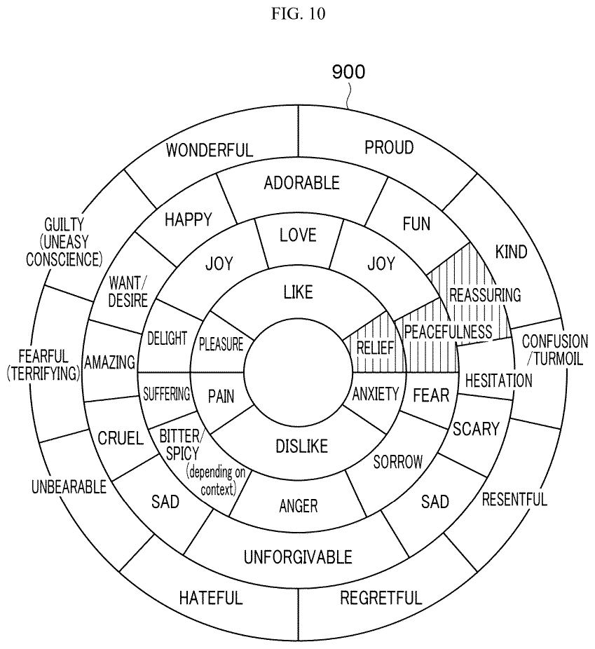

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire input information as text data representing a user request or question regarding a product by performing information exchange with a user via a terminal using a communication device and a communication program,
perform preprocessing including character string normalization processing and structuring processing on the acquired text data to extract feature information indicating an intention of the user and conditions regarding the product and to generate internal representation data, generate, by calling a generative artificial intelligence model via an external information processing service using the internal representation data and the input information as input, a prompt sentence for product recommendation by causing the generative artificial intelligence model to generate an instruction sentence that clarifies a purchase request of the user,
generate recommendation information representing product recommendation content corresponding to the prompt sentence by executing the generative artificial intelligence model or another information retrieval processing using the generated prompt sentence as input,
construct product information including category information of a product and attribute information of the product based on the recommendation information and generate response data for transmitting the product information to the terminal, and
transmit the response data to the terminal via the communication device and the communication program to make the product information presentable to the user.

### Supplementary 2

The system according to supplementary 1,
wherein the processor is configured to
generate, as input to the generative artificial intelligence model, a plurality of messages including a system message and a user message, and perform control to execute stepwise a process for generating the prompt sentence and a process for generating the product recommendation content by embedding the input information and the internal representation data into the user message.

### Supplementary 3

The system according to supplementary 1,
wherein the processor is configured to
store, as history information in a storage device, a correspondence between the prompt sentence for product recommendation and the product recommendation content, and perform control to improve accuracy of presenting personalized product information for each user by changing at least one of an input parameter to the generative artificial intelligence model and contents of the preprocessing based on the history information.

### Application Example 1

### Supplementary 1

A system comprising a processor,
wherein the processor is configured to
acquire, via a communication unit, text information including user request information from a user terminal,
acquire user history information and preference information stored in a storage unit, and integrate the user history information and the preference information with a request content based on the text information to generate user attribute information,
construct, based on template information, an instruction sentence for input to a generative information processing model by using the user attribute information and the text information, and generate the instruction sentence as a prompt sentence,
input the prompt sentence to the generative information processing model, execute natural language processing by the generative information processing model, and extract product candidate information from output information of the generative information processing model,
compare attributes included in the product candidate information with product information stored in a product information storage unit, select product candidates in consideration of the user history information and the preference information, and generate product information to be proposed to a user, and generate response information for transmitting the product information to the user terminal.

### Supplementary 2

The system according to supplementary 1,
wherein the processor is configured to cause the communication unit to use a communication application to transmit and receive the text information and the product information as structured data to and from the user terminal via a network.

### Supplementary 3

The system according to supplementary 1,
wherein the processor is configured to convert the product information into display control information, and to present, on a display device of the user terminal, a list of product candidates in a displayable format including explanation information generated by the generative information processing model.

### Example 2

### Supplementary 1

A system comprising a processor,
wherein the processor is configured to
acquire, via a communication network, character information regarding a product and user identification information from a user terminal operated by a user, and
acquire, based on the user identification information, purchase history information and browsing history information of the user from a behavior history information storage device, perform aggregation processing and tendency extraction processing on the purchase history information and the browsing history information for each attribute, and generate user preference information, and
perform semantic analysis processing on the acquired character information using a natural language processing unit, and extract product type information, constraint condition information, and user intention information, and
generate prompt sentence data including explanation information, condition information, and output format information for configuring a prompt sentence to be input to a generative information processing model, based on the user preference information and the user intention information, and
input the prompt sentence data to the generative information processing model and acquire generated result data including product proposal information from the generative information processing model, and
search a product information storage device based on product attribute information included in the generated result data, generate product candidate information to which inventory information, price information, and display explanation information are added, and transmit the product candidate information as individualized proposal information to the user terminal, and
generate order information based on purchase operation information acquired from the user terminal, and control a settlement processing unit, a packaging instruction unit, a message information generation unit, and a delivery instruction unit to execute processing from purchase to shipment.

### Supplementary 2

The system according to supplementary 1,
wherein the processor is configured to
acquire distribution trend information and popularity information stored in a product category information storage device, in addition to the user preference information and the user intention information, and incorporate the distribution trend information and the popularity information as condition information into the prompt sentence data when generating the prompt sentence data.

### Supplementary 3

The system according to supplementary 1,
wherein the processor is configured to
generate and input, to the generative information processing model, prompt sentence data including creation conditions for a gift message based on the purchase operation information, acquire message information from the generative information processing model, associate the message information with the order information and store the message information, and transmit packaging instruction information including the message information to a delivery processing device.

### Application Example 2

### Supplementary 1

A system comprising a processor,
wherein the processor is configured to
acquire user information by using a communication unit that enables information exchange with a user,
analyze the acquired user information by using a data analysis unit to determine at least one of a user request, a user attribute, a user history, and a user emotional state,
generate a prompt sentence to be input to a generative AI model on the basis of the user information and an analysis result obtained by the data analysis unit, execute a generation process by using the generative AI model on the basis of the prompt sentence, and generate item candidates and description information relating to the item candidates,
acquire item data from an item data storage unit and generate item proposal information by associating the generated item candidates and the description information with the item data, present, on the basis of the item proposal information, at least one of an item, a packaging mode, a decoration, and a message draft to the user and support at least one of a purchase procedure and a delivery arrangement in accordance with a selection made by the user, and store, as history information, a selection result of the user, the prompt sentence input to the generative AI model, and a response content from the generative AI model, and reflect the history information in generation of a subsequent prompt sentence and generation of subsequent item proposal information.

### Supplementary 2

The system according to supplementary 1,
wherein the processor is configured to use, as the communication unit, a communication application that exchanges information with the user via a network, and to cause a display device of a user terminal to individually display the item proposal information, the packaging mode, the decoration, and the message draft.

### Supplementary 3

The system according to supplementary 1,
wherein the processor is configured to use, as the data analysis unit, an emotion analysis unit that performs emotion estimation processing on at least one of history information and text information of the user, and to change at least one of content of the prompt sentence and generation conditions of the item candidates by the generative AI model in accordance with the emotional state obtained by the emotion analysis unit.

What is claimed is:

1. A system comprising:
circuitry configured to:
receive, via a communication interface coupled to a packet-switched network, text data from a terminal device operated by a user;
perform normalization processing on the text data comprising at least one of case conversion, control character removal, or whitespace standardization to generate normalized text data, and perform structuring processing on the normalized text data comprising applying subword segmentation to generate a token sequence and extracting, from the token sequence, an intent indicator and a condition indicator to generate internal representation data encoded as a key-value data structure;
construct a first message set comprising a system message defining a role constraint and a user message embedding the text data and the internal representation data, and invoke a generative neural network model using the first message set as input to generate a prompt sentence;
construct a second message set comprising the prompt sentence, invoke the generative neural network model using the second message set as input to generate response content, and parse the response content by applying sentence segmentation and pattern recognition to extract a plurality of candidate data records each comprising an attribute field and a context field;
compute similarity scores between attribute values in the candidate data records and attribute data stored in a reference data store, calculate ranking scores for entries in the reference data store by combining the similarity scores with preference weight values derived from history records associated with a user identifier stored in a storage device, and select a subset of entries having ranking scores exceeding a threshold value; and
construct structured output data based on the selected subset of entries and transmit the structured output data to the terminal device via the communication interface and the packet-switched network.

2. The system according to claim 1, wherein the structuring processing further comprises applying part-of-speech tagging and dependency parsing to the token sequence using a natural language processing module to identify semantic entities corresponding to a category indicator and a usage context indicator within the internal representation data.

3. The system according to claim 2, wherein the circuitry is configured to validate the generated prompt sentence by verifying that at least one term corresponding to the intent indicator appears in the prompt sentence, and to re-invoke the generative neural network model with adjusted input parameters when the verification fails.

4. The system according to claim 3, wherein the circuitry is configured to apply a transformer architecture comprising self-attention layers as the generative neural network model, and wherein the system message defines a constraint on an output format of the prompt sentence.

5. The system according to claim 1, wherein the circuitry is configured to acquire, based on the user identifier, behavior history records from the storage device, perform aggregation processing on the behavior history records comprising grouping the behavior history records by a plurality of attributes and computing at least one of a frequency count or a recency-weighted score for each group, and integrate resulting statistical values with the internal representation data to generate user attribute information embedded in the user message.

6. The system according to claim 5, wherein the aggregation processing comprises applying a time-decay function to the behavior history records such that records having more recent timestamps receive higher weight values, and computing a preference vector from the weighted records.

7. The system according to claim 6, wherein the circuitry is configured to construct the prompt sentence by applying template information stored in the storage device, the template information defining fixed text segments and placeholder segments, and performing variable substitution to insert values from the user attribute information into the placeholder segments.

8. The system according to claim 1, wherein the circuitry is configured to acquire distribution trend data and popularity data from a category data store, and to incorporate the distribution trend data and the popularity data as condition parameters in the first message set when invoking the generative neural network model.

9. The system according to claim 1, wherein parsing the response content comprises extracting from each candidate data record a type description field, a feature list field, and the context field, and wherein computing the similarity scores comprises encoding the attribute values and the attribute data as numerical vectors and calculating a cosine similarity or a dot-product similarity between the numerical vectors.

10. The system according to claim 9, wherein the circuitry is configured to apply a re-ranking operation to the selected subset of entries by computing a composite score combining the ranking score with a freshness score derived from a timestamp associated with each entry in the reference data store.

11. The system according to claim 1, wherein the circuitry is configured to store, in the storage device, correspondence data associating the prompt sentence with the response content and with selection data received from the terminal device, and to modify at least one of a parameter of the normalization processing, a parameter of the structuring processing, or an input parameter of the generative neural network model based on the stored correspondence data.

12. The system according to claim 11, wherein modifying the parameter comprises adjusting a token vocabulary used in the subword segmentation based on a frequency analysis of terms in the stored correspondence data.

13. The system according to claim 1, wherein the circuitry is configured to generate order data based on selection information received from the terminal device, and to control at least one of a transaction processing module or a fulfillment instruction module to execute processing associated with the order data.

14. The system according to claim 13, wherein the circuitry is configured to generate additional prompt data based on the order data and a context parameter, invoke the generative neural network model using the additional prompt data to generate supplementary content, and associate the supplementary content with the order data for transmission to a processing device via the packet-switched network.

15. The system according to claim 1, wherein the circuitry is configured to estimate an emotional state of the user by applying an emotion identification model to at least one of the text data or sensor data received from the terminal device, and to modify at least one of content of the prompt sentence or a generation condition of the generative neural network model based on the estimated emotional state.

16. The system according to claim 1, wherein the circuitry is configured to search a vector database using a retrieval-augmented generation architecture to acquire reference documents related to the text data, and to input the acquired reference documents together with the internal representation data into the generative neural network model to generate the prompt sentence.

17. The system according to claim 1, wherein the circuitry is configured to monitor a latency metric associated with invocation of the generative neural network model, and to switch between a high-parameter model and a distilled lightweight model based on a comparison of the latency metric with a latency threshold value.

18. A system comprising:
circuitry configured to:
receive, via a communication interface coupled to a packet-switched network, text data from a terminal device;
perform normalization processing and structuring processing on the text data comprising applying subword segmentation to generate a token sequence, applying at least one of part-of-speech tagging or dependency parsing to the token sequence, and extracting an intent indicator and a condition indicator to generate internal representation data encoded as a key-value data structure;
acquire, based on a user identifier, behavior history records from a storage device, perform aggregation processing comprising grouping the behavior history records by a plurality of attributes and computing recency-weighted preference scores, and integrate the preference scores with the internal representation data to generate user attribute information;
construct a first message set comprising a system message and a user message embedding the text data, the internal representation data, and the user attribute information, invoke a generative neural network model using the first message set to generate a prompt sentence, and validate the prompt sentence by verifying presence of at least one term corresponding to the intent indicator;
construct a second message set comprising the validated prompt sentence, invoke the generative neural network model using the second message set to generate response content, parse the response content to extract a plurality of candidate data records, compute similarity scores between attribute values in the candidate data records and attribute data in a reference data store, calculate ranking scores by combining the similarity scores with the preference scores, and select a subset of entries based on the ranking scores; and
construct structured output data based on the selected subset and transmit the structured output data to the terminal device via the communication interface and the packet-switched network.

19. The system according to claim 18, wherein the circuitry is configured to store correspondence data associating the prompt sentence with the response content and with selection data received from the terminal device, and to modify at least one of a normalization parameter, a structuring parameter, or a model input parameter based on the stored correspondence data.

20. A method comprising:
receiving, via a communication interface coupled to a packet-switched network, text data from a terminal device operated by a user;
performing normalization processing on the text data comprising at least one of case conversion, control character removal, or whitespace standardization to generate normalized text data, and performing structuring processing on the normalized text data comprising applying subword segmentation to generate a token sequence and extracting, from the token sequence, an intent indicator and a condition indicator to generate internal representation data encoded as a key-value data structure;
constructing a first message set comprising a system message defining a role constraint and a user message embedding the text data and the internal representation data, and invoking a generative neural network model using the first message set as input to generate a prompt sentence;
constructing a second message set comprising the prompt sentence, invoking the generative neural network model using the second message set as input to generate response content, and parsing the response content by applying sentence segmentation and pattern recognition to extract a plurality of candidate data records each comprising an attribute field and a context field;
computing similarity scores between attribute values in the candidate data records and attribute data stored in a reference data store, calculating ranking scores for entries in the reference data store by combining the similarity scores with preference weight values derived from history records associated with a user identifier stored in a storage device, and selecting a subset of entries having ranking scores exceeding a threshold value; and
constructing structured output data based on the selected subset of entries and transmitting the structured output data to the terminal device via the communication interface and the packet-switched network.
